(19) United States
(12) Patent Application Publication
(10) Pub. No.: US 2025/0190956 A1
(43) Pub. Date: Jun. 12, 2025

(54) Information Processing Method, Information Processing Device, and Non-Transitory Computer-Readable Storage Medium

(71) Applicant: FTF INC., Shibuya-ku, Tokyo (JP)

(72) Inventor: Tomoyuki Katagiri, Shibuya-ku, Tokyo (JP)

(21) Appl. No.: 18/843,059

(22) PCT Filed: Mar. 10, 2023
(86) PCT No.: PCT/JP2023/009240

§ 371 Date: Aug. 30, 2024

(30) Foreign Application Priority Data
Mar. 10, 2022 (JP) 2022-037483

(51) Int. Cl. G06Q 20/06; G06F 21/10; G06Q 30/02; G06Q 30/0601

(52) U.S. Cl. CPC G06Q 20/06; G06F 21/1014; G06Q 30/0278; G06Q 30/0643

(57) ABSTRACT

An information processing method according to one aspect is characterized by executing processing of storing appraisal information including an artist name and a title of an analog record in a storage unit, and outputting a certificate including the artist name and the title of the analog record, on the basis of the appraisal information stored in the storage unit. In addition, preferably, the information processing method is characterized by executing processing of further storing a catalog number, a label name, a label image, a jacket image, a matrix number, a weight, or a production year of the analog record in the storage unit, and outputting the certificate including the artist name, the title, the catalog number, the label name, the label image, the jacket image, the matrix number, the weight, or the production year of the analog record.

### REFERENCE TO RELATED APPLICATIONS

This application is the national phase under 35 U.S.C. § 371 of PCT International Application No. PCT/JP2023/009240 which has International filing date of Mar. 10, 2023 and designated the United States of America, and claiming priority on Patent application No. 2022-037483 filed in Japan on Mar. 10, 2022.

### BACKGROUND ART

In general, when buying and selling a product, an artwork, or the like, an authenticity appraisal is performed to determine whether the product or the artwork is genuine or fake, and a certificate that is capable of certifying authenticity is issued. In Japanese Patent Laid-Open Publication No. 2017-039226, a sword certificate and a sword appraisal method are disclosed.

### DESCRIPTION

However, the invention according to Japanese Patent Laid-Open Publication No. 2017-039226 has a problem that it is not possible to output (issue) a certificate for an analog record.

In one aspect, an object is to provide an information processing method or the like, in which it is possible to output a certificate for an analog record.

An information processing method according to one aspect is characterized by executing processing of storing appraisal information including an artist name and a title of an analog record in a storage unit, and outputting a certificate including the artist name and the title of the analog record, on the basis of the appraisal information stored in the storage unit.

In one aspect, it is possible to output the certificate for the analog record.

The above and further objects and features will more fully be apparent from the following detailed description with accompanying drawings.

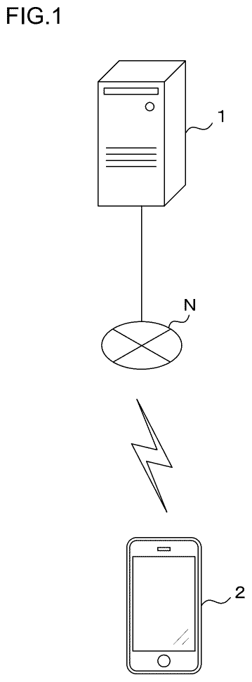

FIG. 1 is an explanatory diagram illustrating an outline of a certificate issue system.

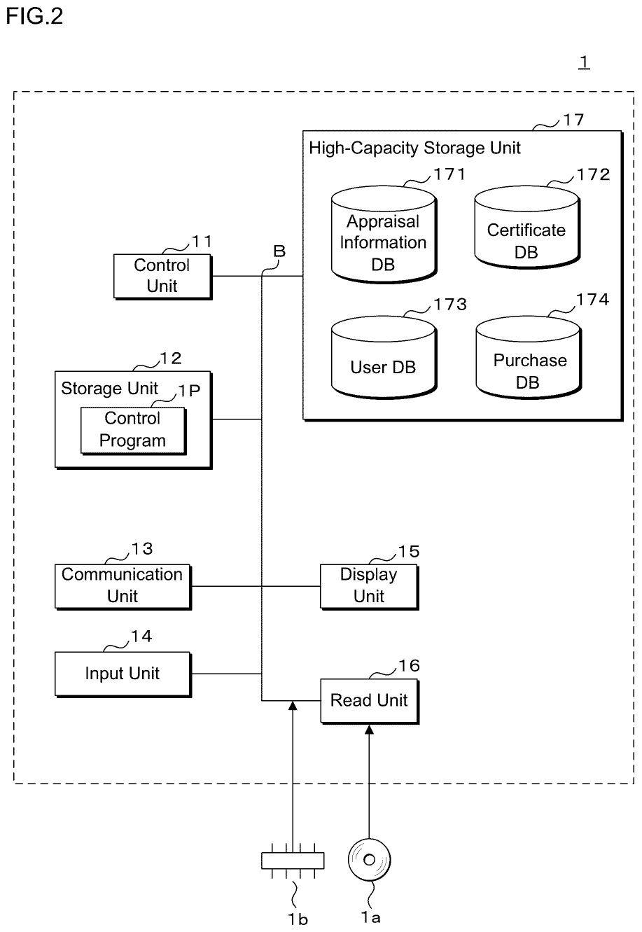

FIG. 2 is a block diagram illustrating a configuration example of a server.

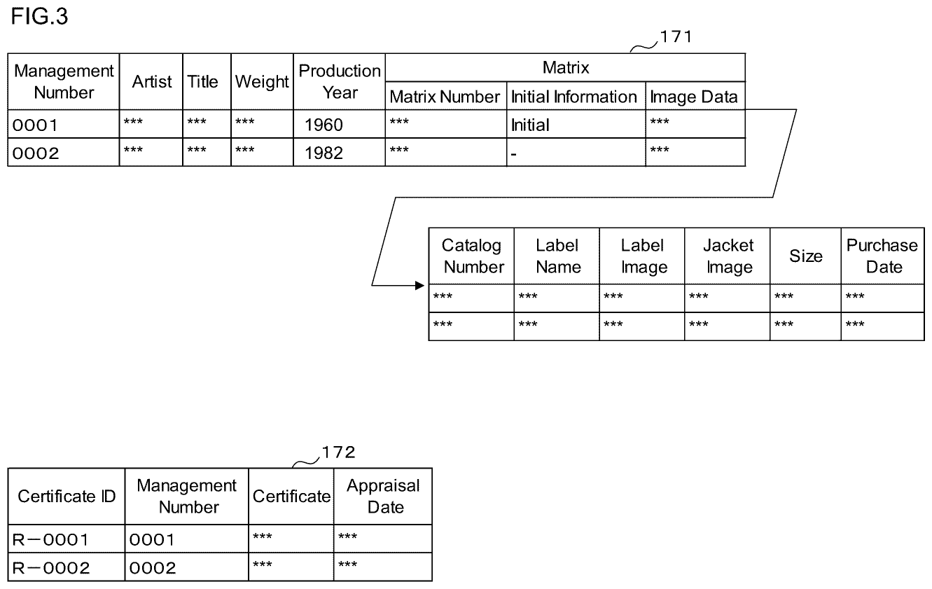

FIG. 3 is an explanatory diagram illustrating an example of a record layout of an appraisal information DB and a certificate DB.

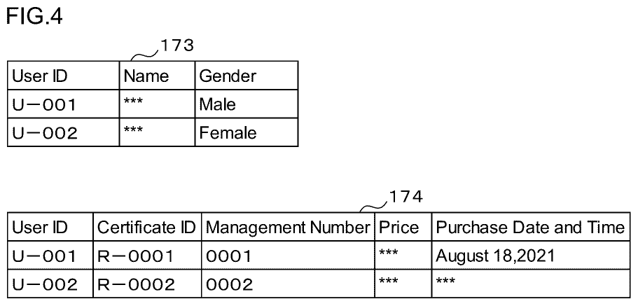

FIG. 4 is an explanatory diagram illustrating an example of a record layout of a user DB and a purchase DB.

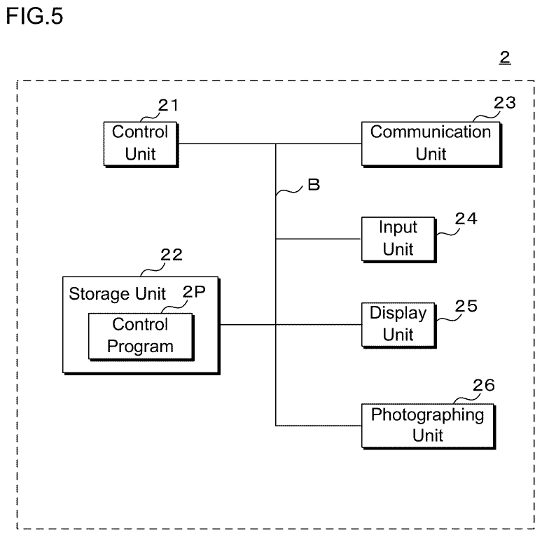

FIG. 5 is a block diagram illustrating a configuration example of a user terminal.

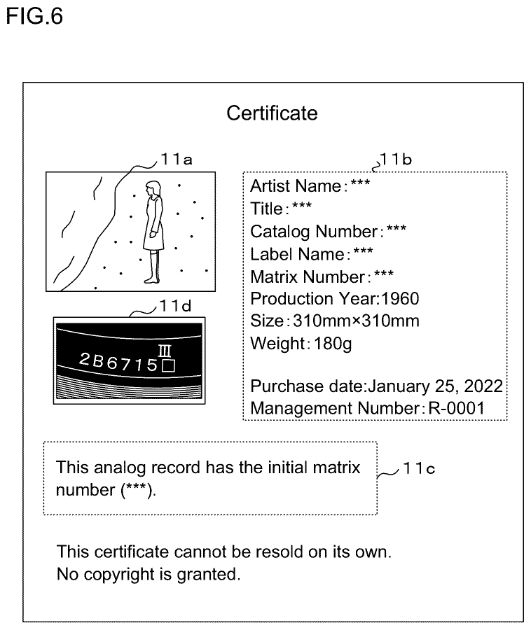

FIG. 6 is an explanatory diagram illustrating an example of a display screen of a certificate.

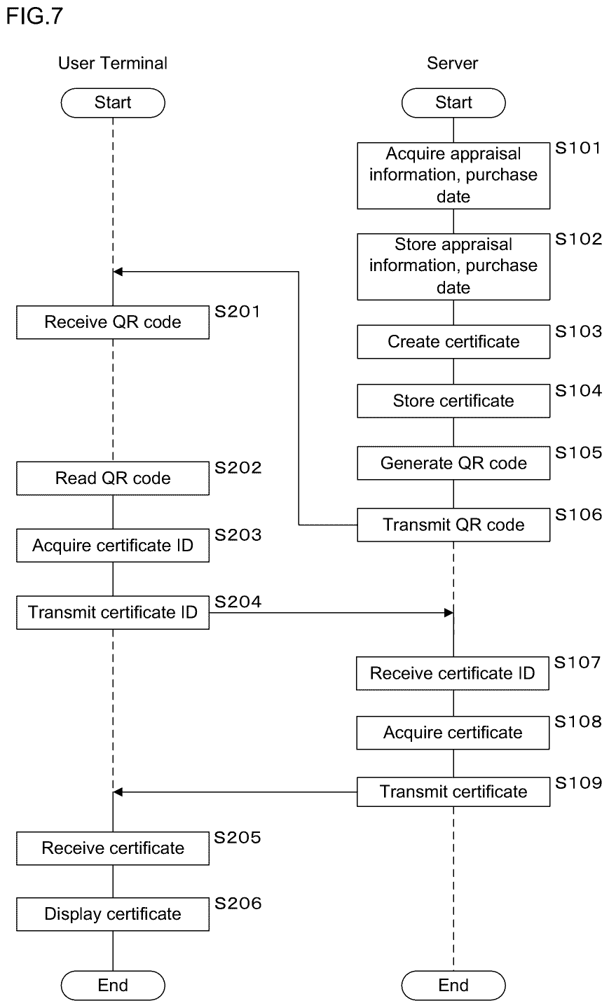

FIG. 7 is a flowchart illustrating a processing procedure when outputting a certificate.

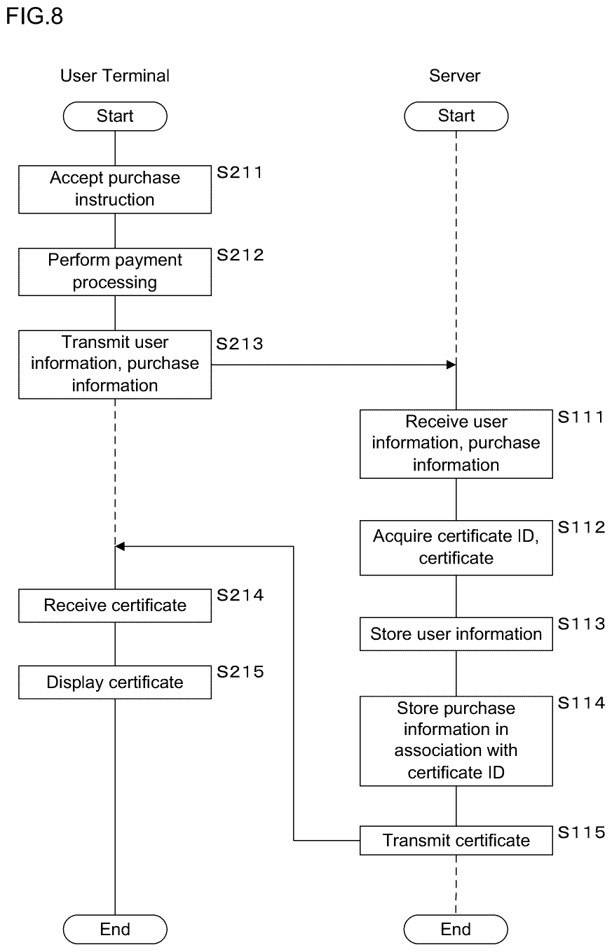

FIG. 8 is a flowchart illustrating a processing procedure when storing user information of a user who purchases an analog record.

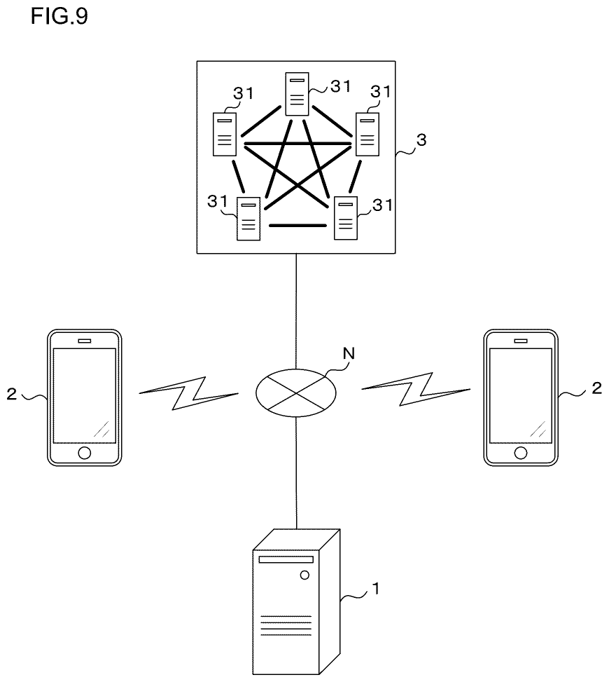

FIG. 9 is an explanatory diagram illustrating an outline of a certificate issue system in Embodiment 2.

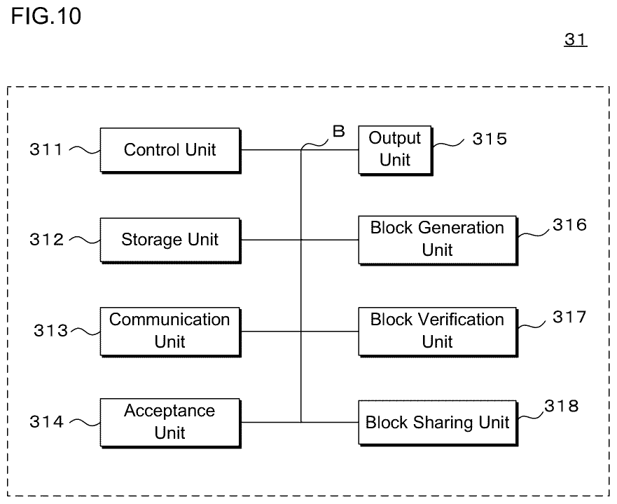

FIG. 10 is a block diagram illustrating a configuration example of a node of a blockchain.

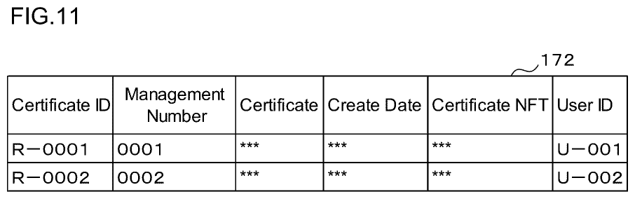

FIG. 11 is an explanatory diagram illustrating an example of a record layout of a certificate DB in Embodiment 2.

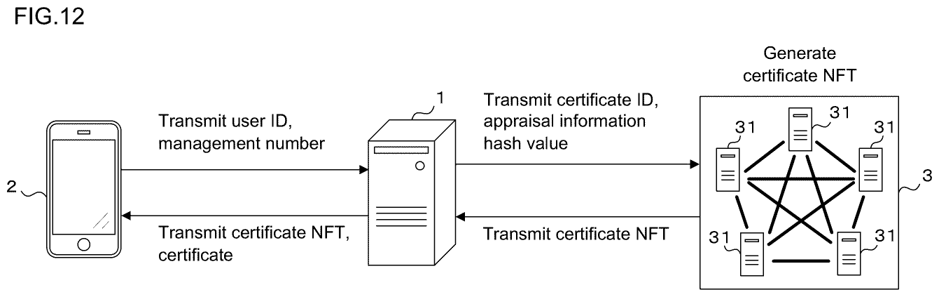

FIG. 12 is an explanatory diagram illustrating processing of issuing a certificate NFT.

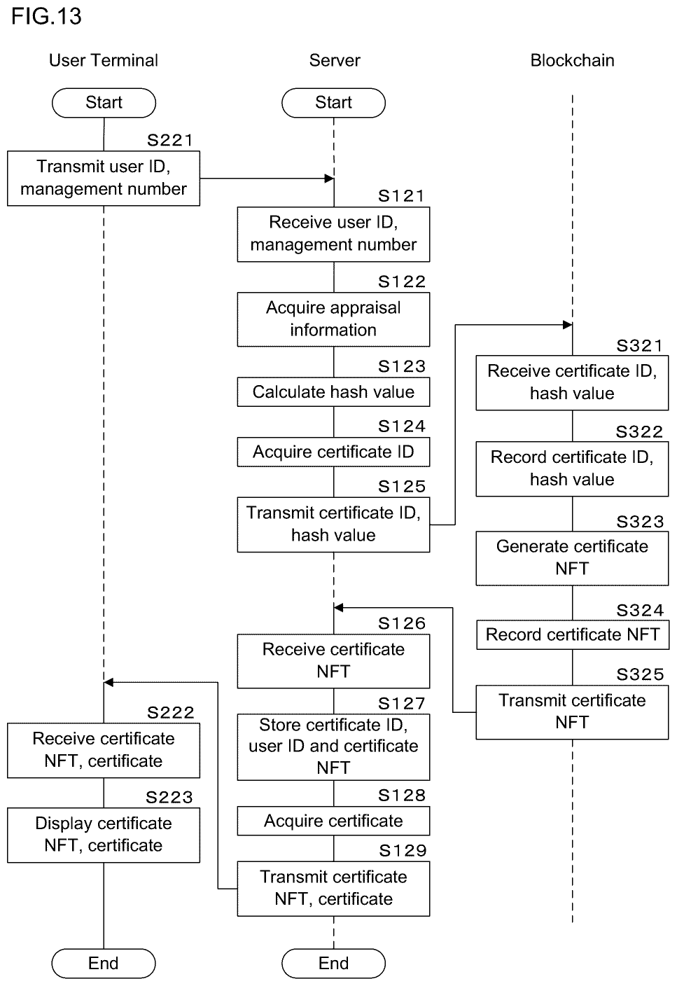

FIG. 13 is a flowchart illustrating a processing procedure when issuing a certificate NFT.

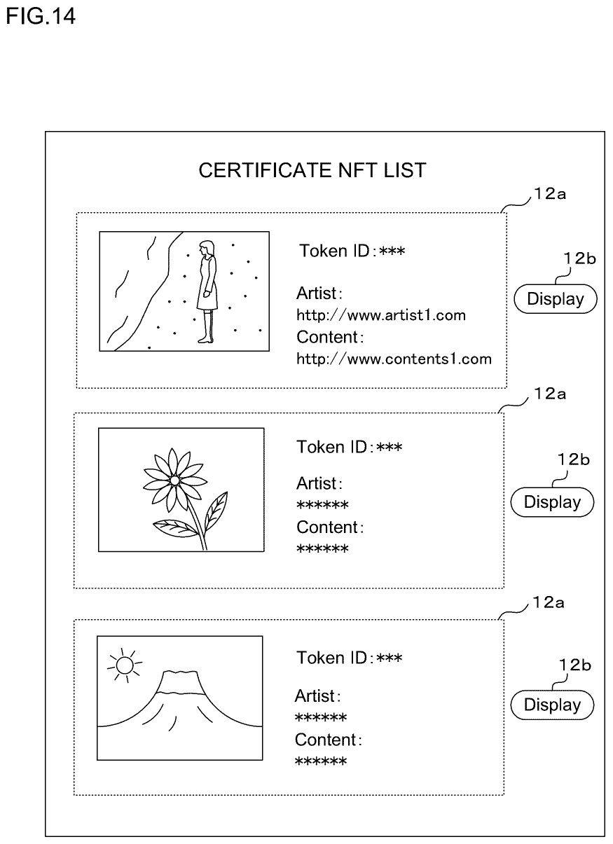

FIG. 14 is an explanatory diagram illustrating an example of a list screen of a certificate NFT.

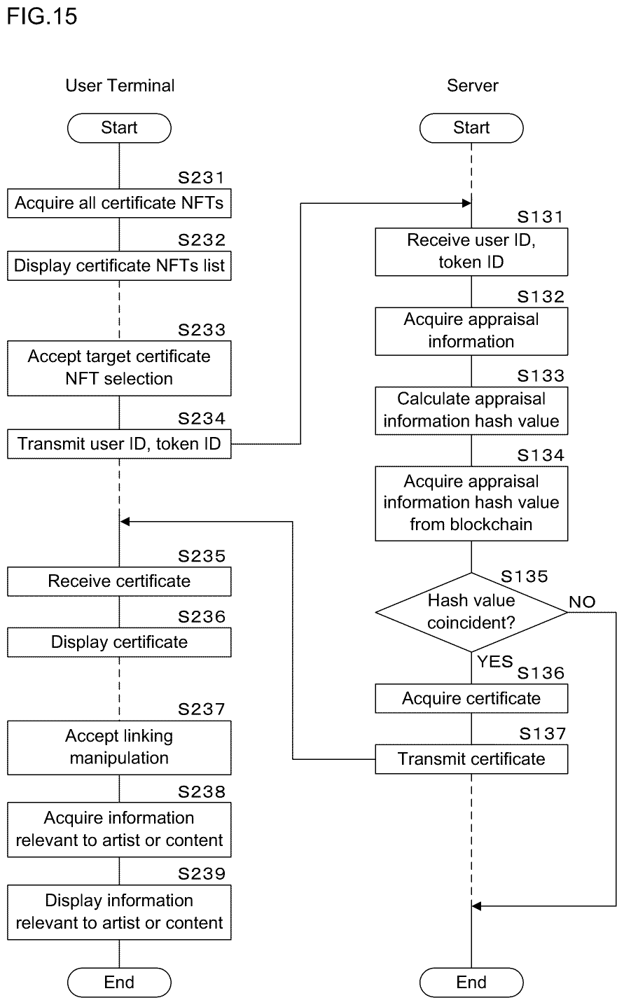

FIG. 15 is a flowchart illustrating a processing procedure when outputting information relevant to an artist and a content.

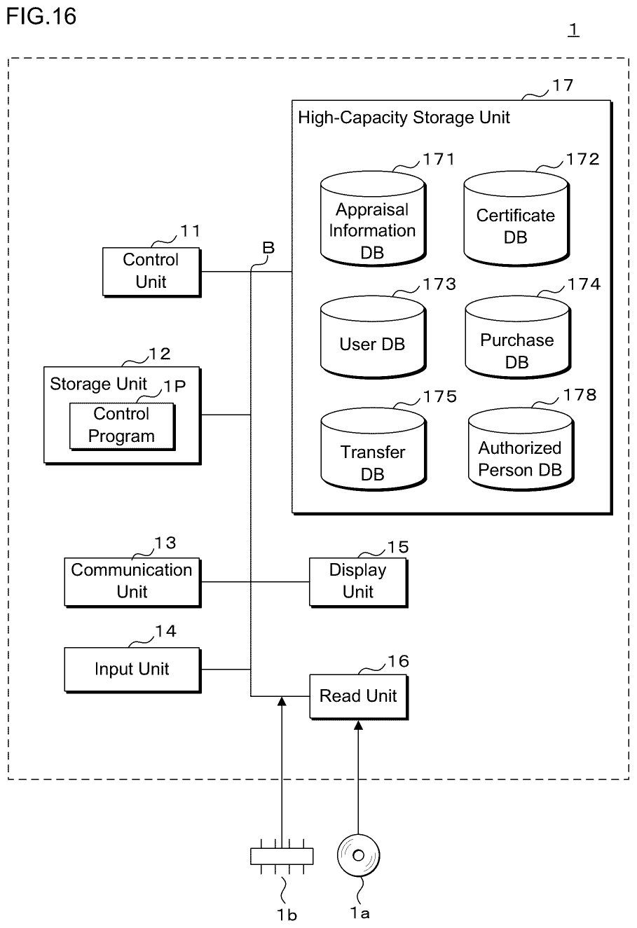

FIG. 16 is a block diagram illustrating a configuration example of a server in Embodiment 3.

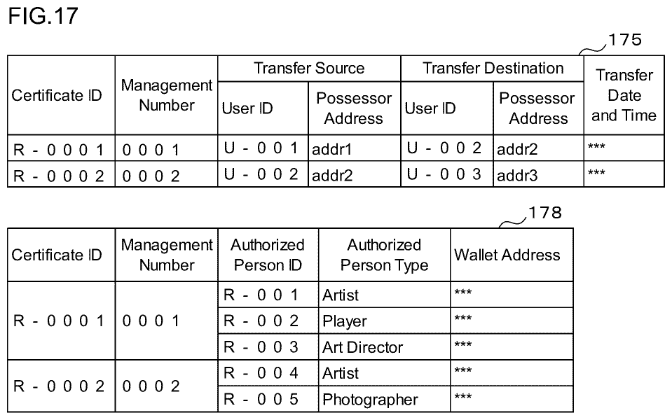

FIG. 17 is an explanatory diagram illustrating an example of a record layout of a transfer DB.

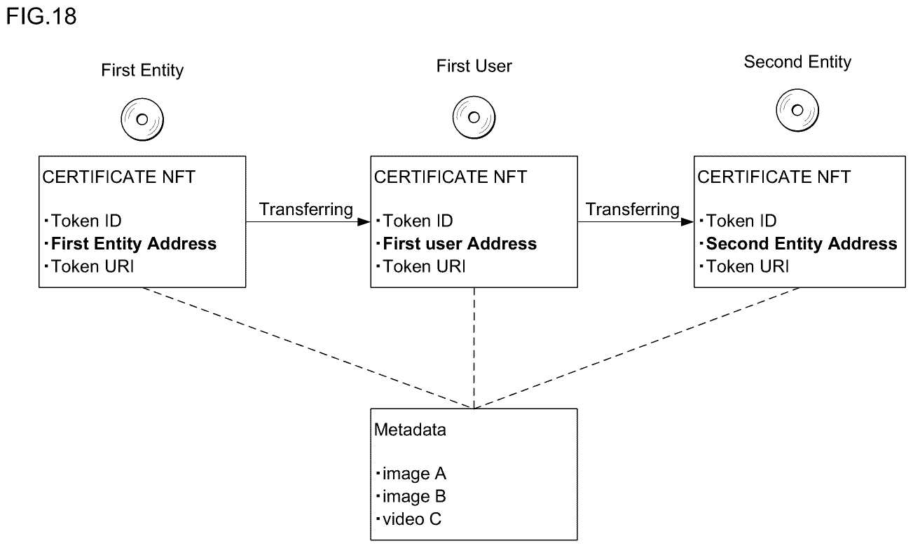

FIG. 18 is an explanatory diagram illustrating processing of transferring a certificate NFT.

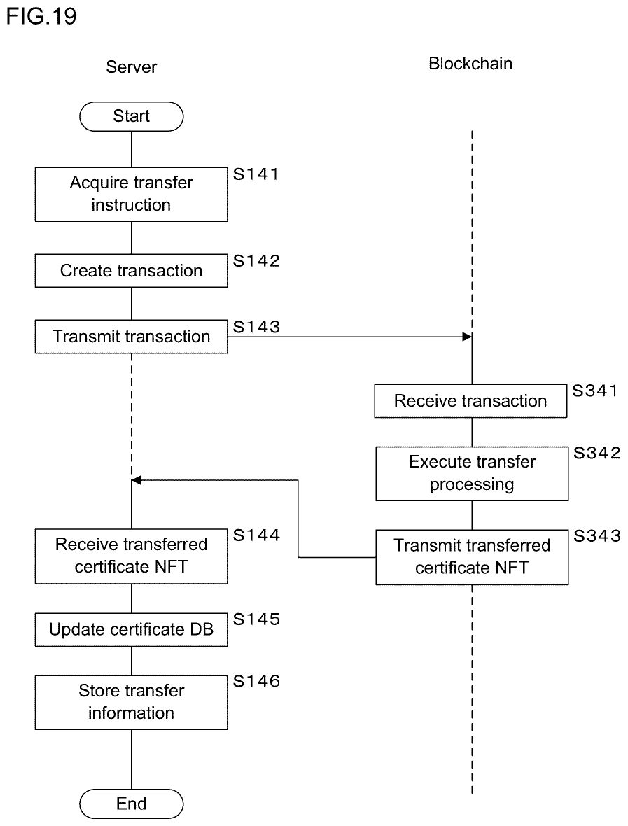

FIG. 19 is a flowchart illustrating a processing procedure when transferring a certificate NFT.

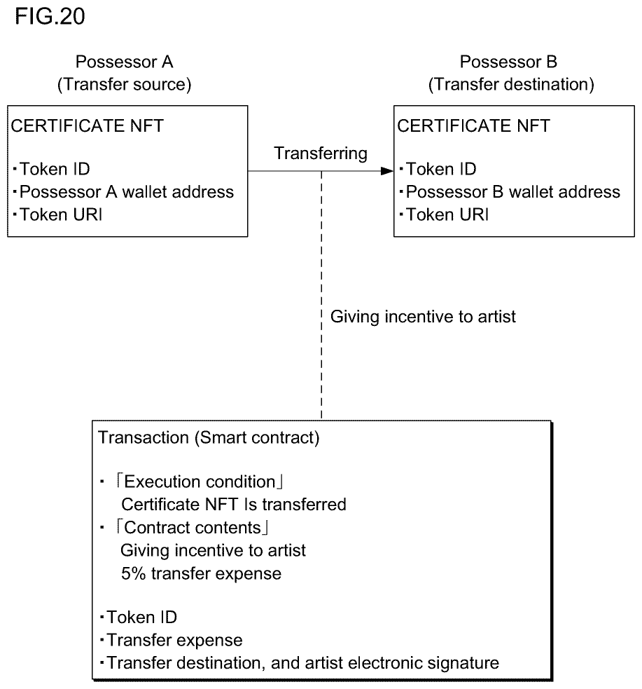

FIG. 20 is an explanatory diagram illustrating processing of giving an incentive to an artist by a smart contract.

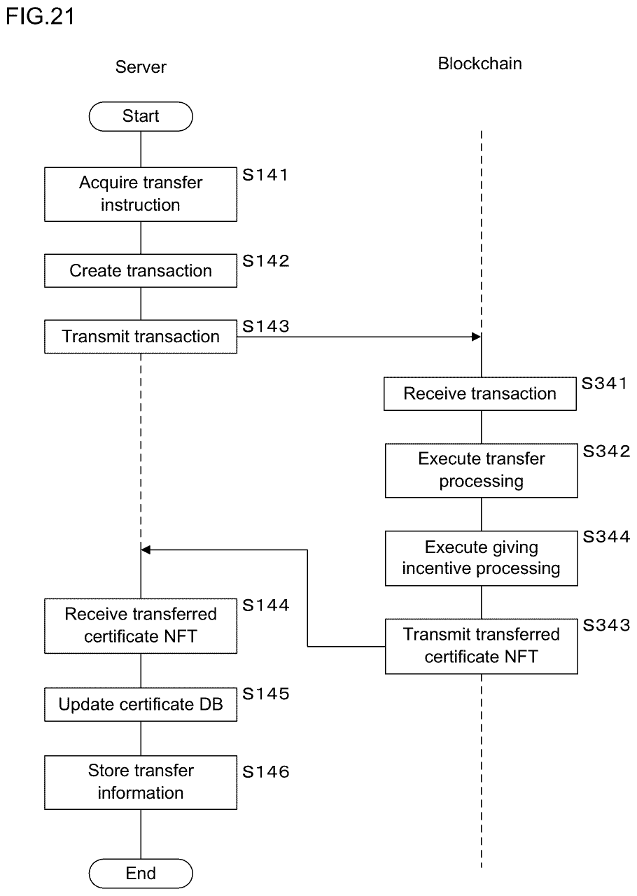

FIG. 21 is a flowchart illustrating a processing procedure when giving an incentive by transferring a certificate NFT.

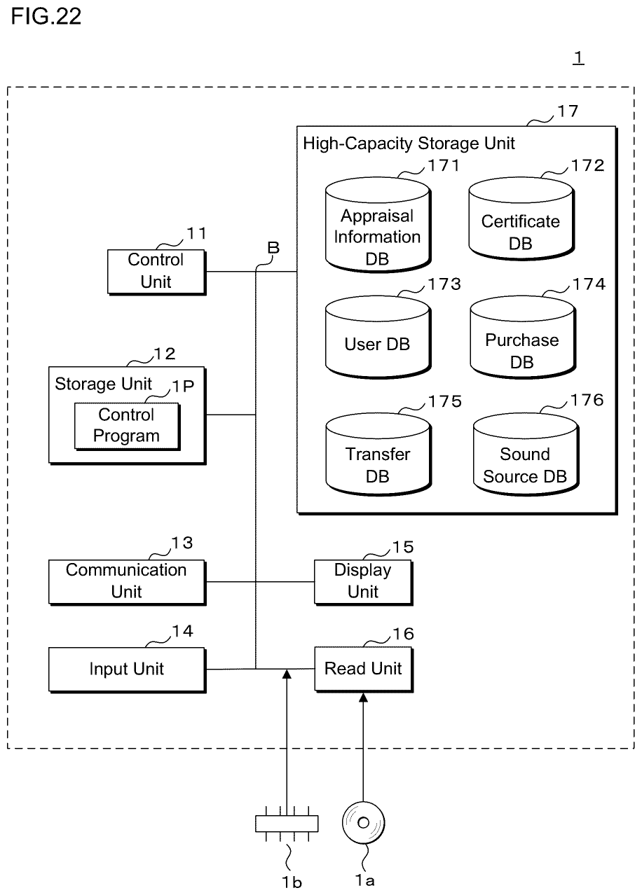

FIG. 22 is a block diagram illustrating a configuration example of a server in Embodiment 4.

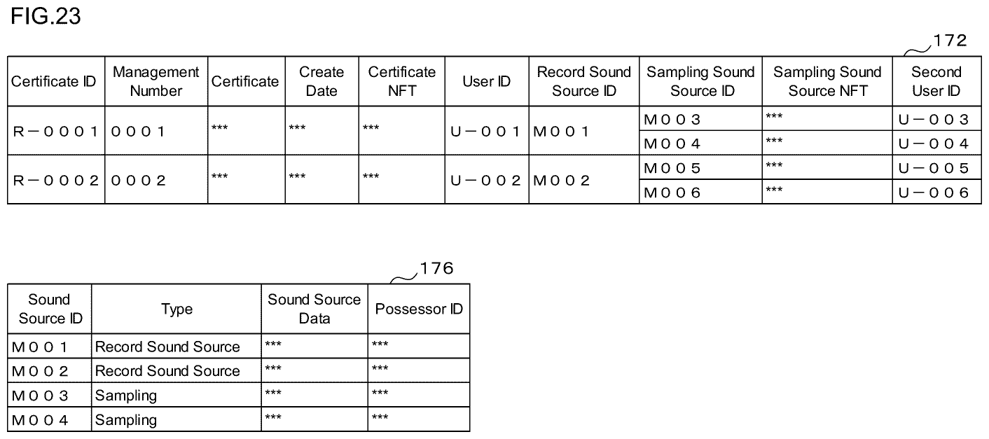

FIG. 23 is an explanatory diagram illustrating an example of a record layout of a certificate DB and a sound source DB in Embodiment 4.

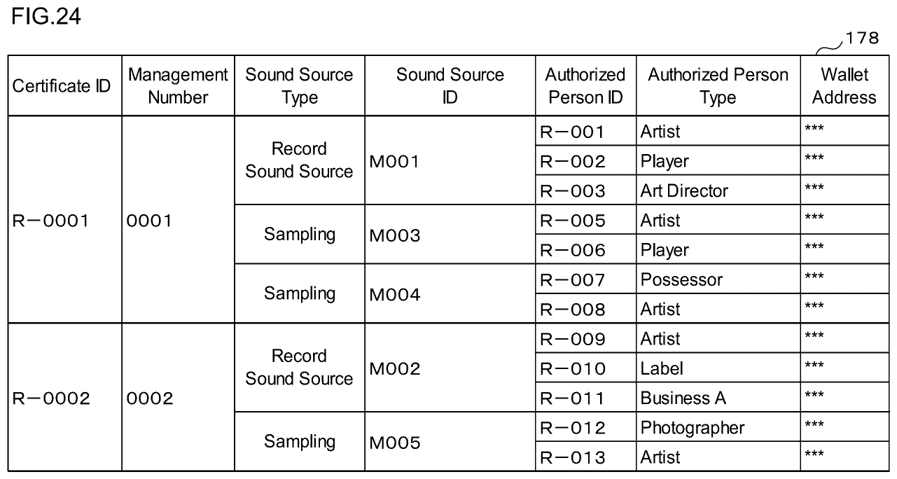

FIG. 24 is an explanatory diagram illustrating an example of a record layout of an authorized person DB in Embodiment 4.

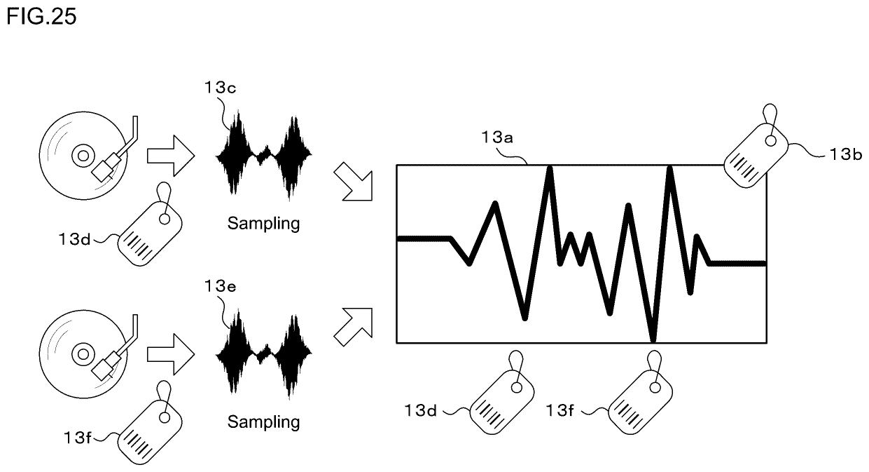

FIG. 25 is an explanatory diagram illustrating a sampling sound source NFT corresponding to sound source data of a sampling.

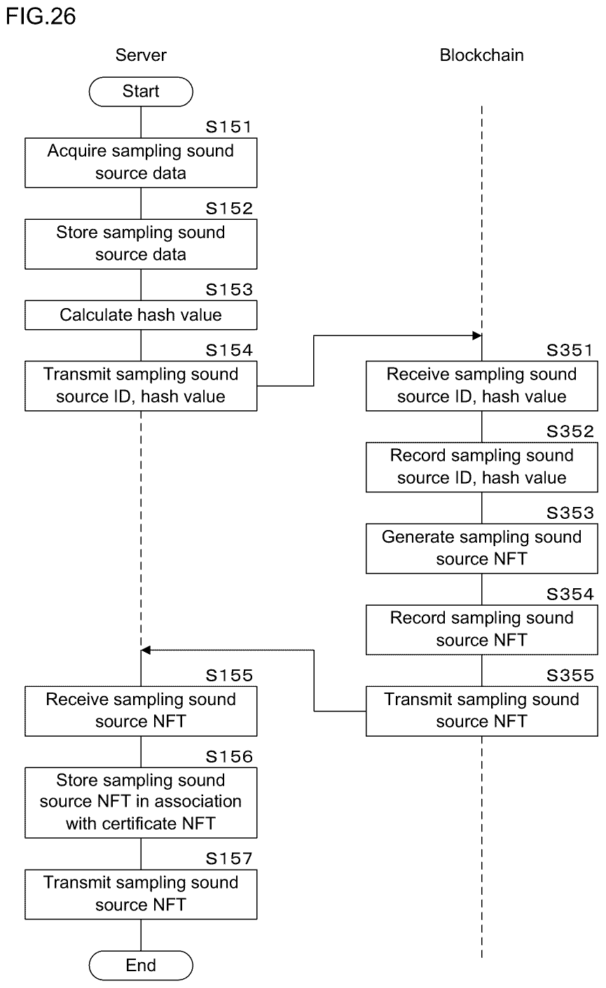

FIG. 26 is a flowchart illustrating a processing procedure when issuing a sampling sound source NFT.

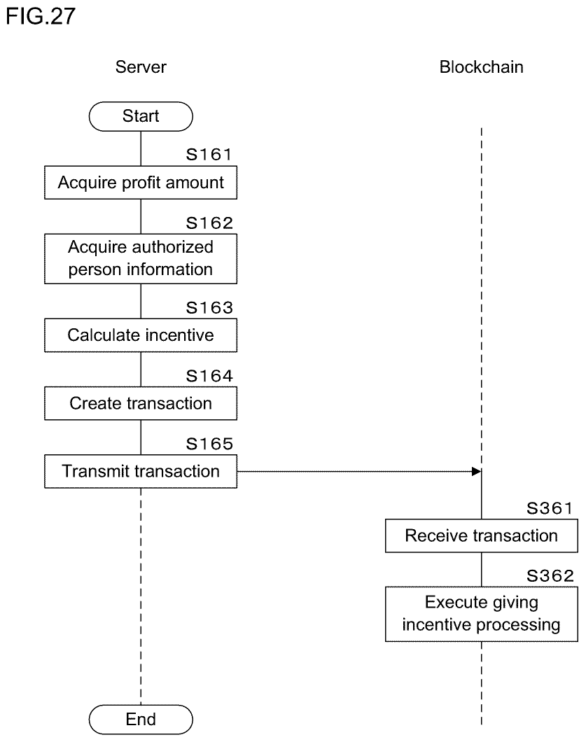

FIG. 27 is a flowchart illustrating a processing procedure when giving an incentive to an authorized person of sound source data of a sampling.

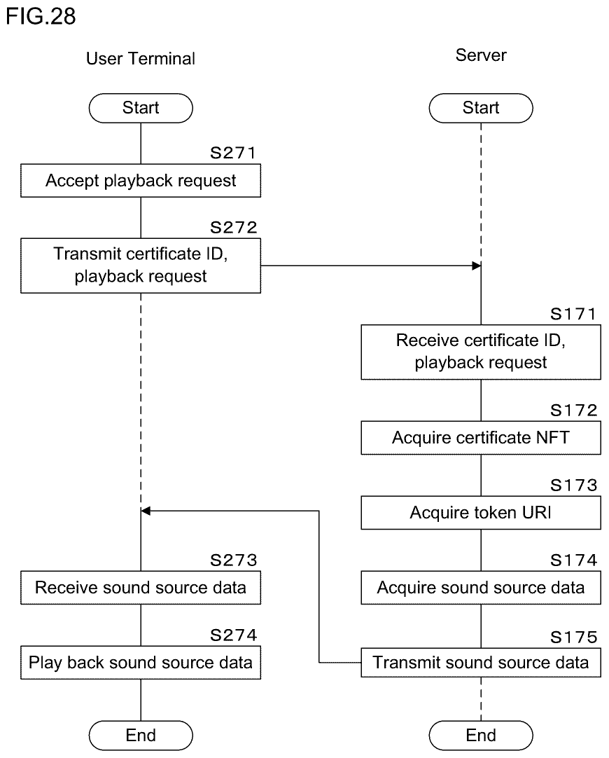

FIG. 28 is a flowchart illustrating a processing procedure when outputting sound source data by a playback request for sound source data.

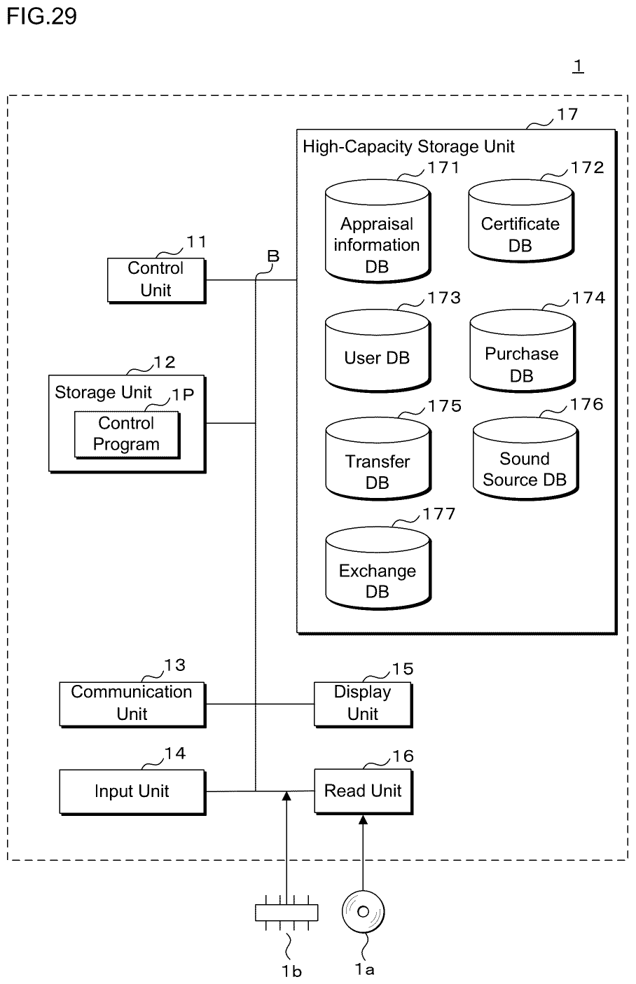

FIG. 29 is a block diagram illustrating a configuration example of a server in Embodiment 6.

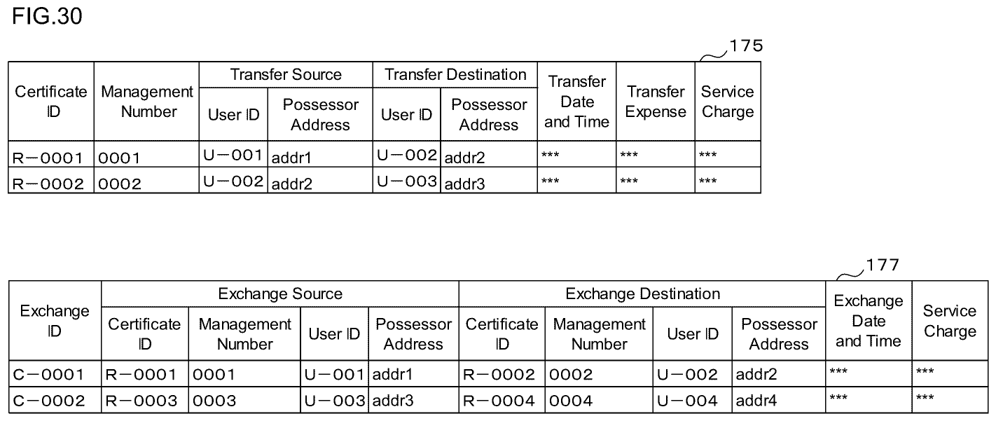

FIG. 30 is an explanatory diagram illustrating an example of a record layout of a transfer DB and an exchange DB in Embodiment 6.

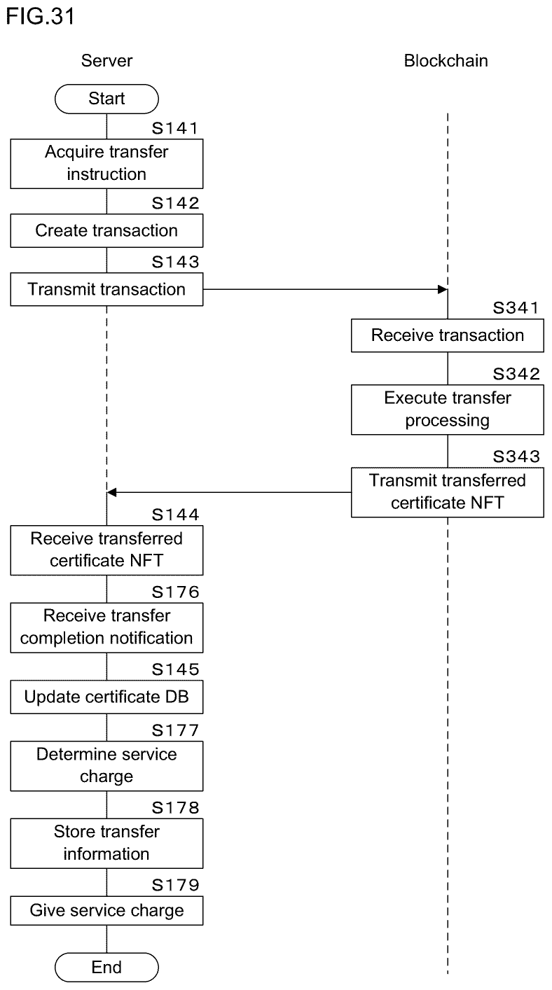

FIG. 31 is a flowchart illustrating a processing procedure when determining a service charge involved in a transfer.

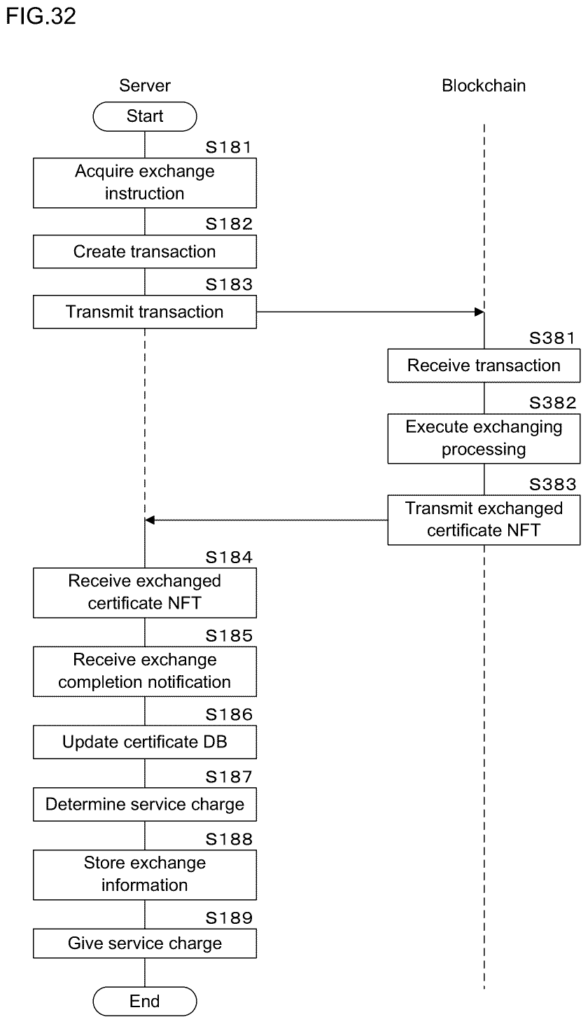

FIG. 32 is a flowchart illustrating a processing procedure when determining a service charge involved in an exchange.

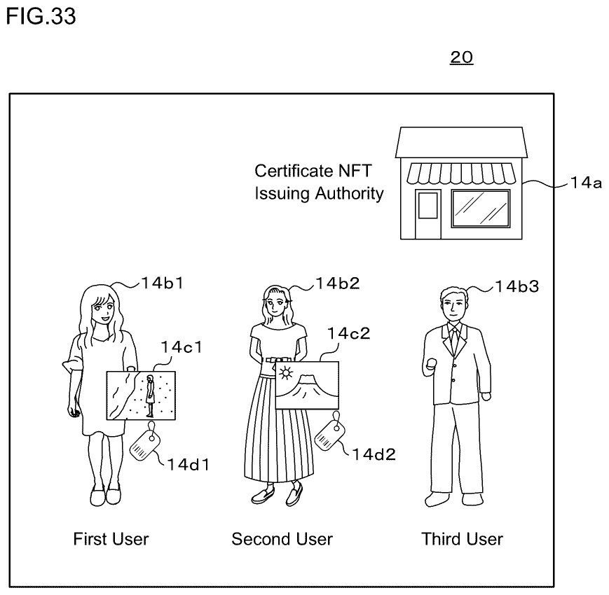

FIG. 33 is an explanatory diagram illustrating an example of a display screen of a metaverse space.

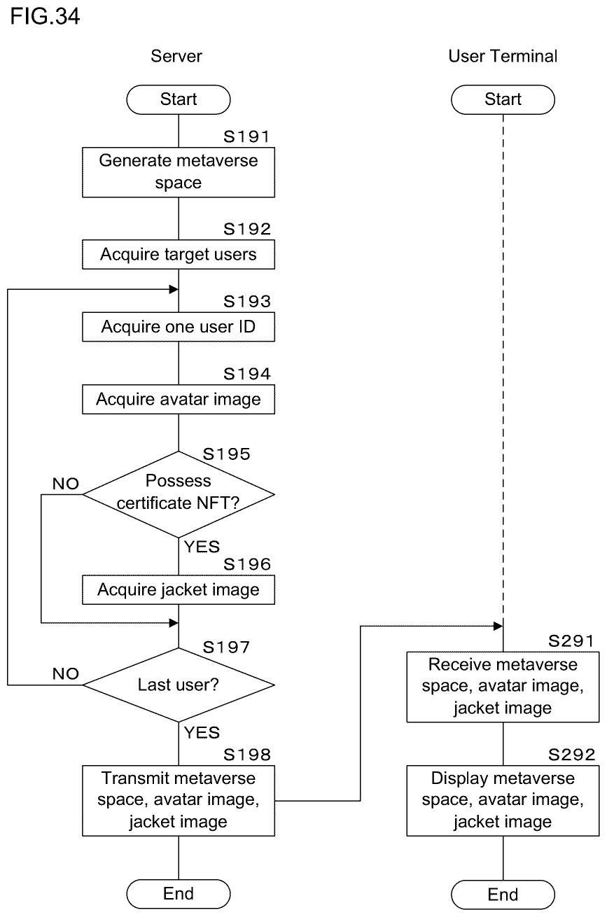

FIG. 34 is a flowchart illustrating a processing procedure when displaying an avatar image and a jacket image in a metaverse space.

Hereinafter, the present invention will be described in detail on the basis of the drawings illustrating embodiments thereof.

### Embodiment 1

Embodiment 1 relates to a configuration in which a certificate for an analog record is output on the basis of appraisal information of the analog record. FIG. 1 is an explanatory diagram illustrating the outline of a certificate issue system. The system of this embodiment includes an information processing device 1 and an information processing terminal 2, and each device performs reception and transmission of information through a network N such as the internet.

The information processing device 1 is an information processing device that performs processing, storage, and reception and transmission on various types of information. The information processing device 1, for example, is a server device, a personal computer, general-purpose tablet personal computer (PC), and the like. In this embodiment, the information processing device 1 is a server device, and hereinafter, will be referred to as the server 1 for simplicity.

The information processing terminal 2 is a terminal device performing the purchase of the analog record, the reception and the display of the certificate for the analog record, and the like. The information processing terminal 2, for example, is an information processing device such as a smart phone, a mobile phone, a wearable device such as Apple Watch (registered trademark), a tablet, or a personal computer terminal. Hereinafter, for simplicity, the information processing terminal 2 will be referred to as a user terminal 2.

The server 1 according to this embodiment acquires the appraisal information of the analog record, and stores the acquired appraisal information in a storage unit. The server 1 creates (generates) the certificate for the analog record, on the basis of the appraisal information. The server 1 allocates a certificate ID for identifying the certificate to the created certificate. The server 1 stores the certificate for the analog record in the storage unit, in association with the allocated certificate ID. The server 1 outputs the created certificate to the user terminal 2.

FIG. 2 is a block diagram illustrating a configuration example of the server 1. The server 1 includes a control unit 11, a storage unit 12, a communication unit 13, an input unit 14, a display unit 15, a read unit 16, and a high-capacity storage unit 17. Each configuration is connected by a bus B.

The control unit 11 includes an arithmetic processing device such as a central processing unit (CPU), a micro-processing unit (MPU), a graphics processing unit (GPU), a field programmable gate array (FPGA), a digital signal processor (DSP), or a quantum processor. The control unit 11 reads out and executes a control program 1P (a program product) stored in the storage unit 12 to perform various types of information processing, control processing, and the like according to the server 1.

Note that the control program 1P can be deployed on a single computer or one site, or can be decompressed to be distributed to a plurality of sites and executed on a plurality of computers connected to each other by a communication network. Note that in FIG. 2, the control unit 11 is illustrated as a single processor, but the control unit may be a multiprocessor.

The storage unit 12 includes a memory element such as a random access memory (RAM) and a read only memory (ROM), and stores the control program 1P, data, or the like, required for the control unit 11 to execute processing. In addition, the storage unit 12 temporarily stores the data or the like, required for the control unit 11 to execute arithmetic processing. The communication unit 13 is a communication module for performing processing relevant to communication, and performs the reception and transmission of information with respect to the user terminal 2 or the like through the network N.

The input unit 14 is an input device such as a mouse, a keyboard, a touch panel, or a button, and outputs manipulation information that is accepted to the control unit 11. The display unit 15 is a liquid crystal display, an organic electroluminescence (EL) display, or the like, and displays various types of information in accordance with the instruction of the control unit 11.

The read unit 16 reads a portable storage medium 1a including a compact disc (CD)-ROM or a digital versatile disc (DVD)-ROM. The control unit 11 may read the control program 1P from the portable storage medium T a through the read unit 16, and may store the control program in the high-capacity storage unit 17. In addition, the control unit 11 may download the control program 1P from other computers through the network N or the like, and may store the control program in the high-capacity storage unit 17. In addition, the control unit 11 may read in the control program 1P from a semiconductor memory 1b.

The high-capacity storage unit 17, for example, includes a recording medium such as a hard disk drive (HDD: a hard disk) and a solid state drive (SSD). The high-capacity storage unit 17 includes an appraisal information database (DB) 171, a certificate DB 172, a user DB 173, and a purchase DB 174.

The appraisal information DB 171 stores the appraisal information of the analog record. The certificate DB 172 stores information relevant to the certificate (a digital certificate) for the analog record. The user DB 173 stores information relevant to a user. The purchase DB 174 stores information relevant to the purchase (an acquisition) of the analog record.

Note that in this embodiment, the storage unit 12 and the high-capacity storage unit 17 may be configured as an integrated storage device. In addition, the high-capacity storage unit 17 may be composed of a plurality of storage devices. In addition, the high-capacity storage unit 17 may be an external storage device connected to the server 1.

The server 1 may execute various types of information processing, control processing, and the like by a single computer, or may execute various types of processing by distributing the processing to a plurality of computers. In addition, the server 1 may be attained by a plurality of virtual machines provided in one server, or may be attained by using a cloud server.

FIG. 3 is an explanatory diagram illustrating an example of the record layout of the appraisal information DB 171 and the certificate DB 172.

The appraisal information DB 171 includes a management number column, an artist column, a title column, a weight column, a production year column, a matrix column, a catalog number column, a label name column, a label image column, a jacket image column, a size column, and a purchase date column. In the management number column, the management number (ID) of the analog record that is uniquely specified is stored in order to identify each analog record.

In the artist column, the artist name of the analog record, an artist ID for specifying the artist of the analog record, or the like is stored. In the title column, the title of the analog record is stored. In the weight column, the weight of the analog record is stored. In the production year column, the year when the analog record is produced is stored.

In the matrix column, a matrix number column, an initial information column, and an image data column are stored. In the matrix number column, the matrix number of the analog record is stored. The matrix number is a number carved on a casting mold (a metallic mold) used when the analog record is produced.

In the initial information column, information indicating the initial matrix number of the analog record is stored. For example, in a case where the matrix number is the initial matrix number, in the initial information column, “initial” is stored. Alternatively, in a case where the matrix number is not the initial matrix number, in the initial information column, “-” or a blank is stored.

When producing a master disk (a lacquer disk) to be the analog record, as one production method, a resin is compressed in a heated casting mold to produce the master disk, and the matrix number is carved on the master disk in the form of a groove. The master disk is the original disk that is produced from a master tape and is directly pressed to the analog record. In general, tens of thousands of analog records can be reproduced from one master disk. Due to the limitation on the number of reproductions from the master disk, a new master is created each time when a large number of presses, additional presses, or re-presses are performed. Then, since the matrix number of the master disk is assigned in order from the number previously made, there is a tendency that as the number decreases, the number of times of playing back the master tape decreases, and the sound is excellent. Since the sound quality is excellent as the matrix number decreases, the analog record on which the initial matrix number is carved has an advantage that the analog record is highly valuable.

In the image data column, the image data of the matrix number is stored. The image data of the matrix number is image data obtained by photographing the matrix number carved on a portion of a soundless groove on the inner circumference of the analog record. In addition, in a case where the matrix number is carved, the alphabet name (for example, LM) of a producer, a special sign or figure, and the like can be carved together with the matrix number. For example, in a case where the image data of the matrix number including the alphabet, the sign or the figure, and the like is acquired, the analog record can be specified by using an image recognition technology or the like. In addition, since the matrix number is carved on the portion of the soundless groove by handwriting or machine punching, the carving depth of the matrix number may be different in accordance with the strength of the punching. For example, by comparing a difference between the image data of the matrix number with a shallow carving and the image data of the matrix number with a deep carving for the same matrix number, it is possible to determine the authenticity of the analog record.

In the catalog number column, the catalog number of the analog record is stored. The catalog number is a code number (a model number) numbered by a production company or the like of the analog record for sale management. In addition, the catalog number, in general, is uniquely numbered, and is printed on the label or the like of the analog record. In the label name column, the name of the label is stored. In the label image column, the image data of the label is stored.

In the jacket image column, the image data of the jacket of the analog record is stored. In the size column, the size of the jacket is stored. In the purchase date column, the date when the analog record is purchased is stored. Note that the sale date of the analog record may be stored in the appraisal information DB 171.

The certificate DB 172 includes a certificate ID column, a management number column, a certificate column, and an appraisal date column. In the certificate ID column, the ID of the certificate that is uniquely specified is stored in order to identify the certificate for each analog record. In the management number column, the management number of the analog record corresponding to the certificate is stored. In the certificate column, the data of the certificate or a file in which the contents of the certificate are described is stored. For example, a portable document format (PDF) file in which the contents of the certificate are described may be stored in the certificate column. In the appraisal date column, the date when the analog record is appraised is stored.

FIG. 4 is an explanatory diagram illustrating an example of the record layout of the user DB 173 and the purchase DB 174.

The user DB 173 includes a user ID column, a name column, and a gender column. In the user ID column, the ID of the user that is uniquely specified is stored in order to identify each user. In the name column, the name of the user is stored. In the gender column, the gender of the user is stored. Note that information stored in the user DB 173 is not limited to the user ID, the name, and the gender. For example, information such as the age or the address of the user may be stored in the user DB 173.

The purchase DB 174 includes a user ID column, a certificate ID column, a management number column, a price column, and a purchase date and time column. In the user ID column, the user ID for specifying the user is stored. In the certificate ID column, the certificate ID for specifying the certificate for the analog record is stored. In the management number column, the management number of the analog record corresponding to the certificate is stored. In the price column, the purchase price of the analog record is stored. In the purchase date and time column, the information of the date and time when the analog record is purchased is stored.

Note that the storage format of each DB described above is an example, and other storage formats may be used insofar as a relationship between pieces of data is maintained.

FIG. 5 is a block diagram illustrating a configuration example of the user terminal 2. The user terminal 2 includes a control unit 21, a storage unit 22, a communication unit 23, an input unit 24, a display unit 25, and a photographing unit 26. Each configuration is connected by a bus B.

The control unit 21 includes an arithmetic processing device such as a CPU, an MPU, an FPGA, an DSP, or a quantum processor, reads out and executes a control program 2P (a program product) stored in the storage unit 22 to perform various types of information processing, control processing, and the like according to the user terminal 2. Note that in FIG. 5, the control unit 21 is illustrated as a single processor, but the control unit may be a multiprocessor.

The storage unit 22 includes a memory element such as a RAM and a ROM, and stores the control program 2P, data, or the like, required for the control unit 21 to execute processing. In addition, the storage unit 22 temporarily stores the data or the like, required for the control unit 21 to execute arithmetic processing.

The communication unit 23 is a communication module for performing processing relevant to communication, and performs the reception and transmission of information with respect to the server 1 or the like through the network N. The input unit 24 may be a keyboard, a mouse, or a touch panel integrated with the display unit 25. The display unit 25 is a liquid crystal display, an organic EL display, or the like, and displays various types of information in accordance with the instruction of the control unit 21.

The photographing unit 26, for example, is a photographing device such as a charge coupled device (CCD) camera or a complementary metal oxide semiconductor (CMOS) camera. Note that the photographing unit 26 may not be built in the user terminal 2, and may be configured by being directly connected to the user terminal 2 on the outside such that the photographing is available.

Subsequently, the processing operation of the certificate issue system will be described. The server 1 acquires the appraisal information of the analog record, and the purchase date of the analog record. For example, the server 1 may acquire the appraisal information and the purchase date by the input unit 14, or may acquire the appraisal information and the purchase date from an external information processing device.

The appraisal information includes the artist name, the title, the catalog number, the label name, the label image, and the jacket image of the analog record, the size of the jacket, the weight, the production year, the matrix number, and the information indicating the initial matrix number of the analog record, or the image data of the matrix number.

The server 1 allocates the management number of the analog record to the acquired appraisal information. The server 1 stores the acquired appraisal information and purchase date in the appraisal information DB 171 in association with the allocated management number. The server 1 creates the certificate for the analog record, on the basis of the appraisal information.

For example, in the certificate, the artist name and the title may be included. Alternatively, in the certificate, the artist name, the title, the catalog number, and the label name may be included. Alternatively, in the certificate, the artist name, the title, the catalog number, the label name, the label image, the jacket image, the matrix number, and the weight or the production year of the analog record may be included. Alternatively, in the certificate, the artist name, the title, the matrix number, and the information indicating the initial matrix number may be included.

Alternatively, in the certificate, the artist name, the title, the matrix number, and the image data of the matrix number may be included. In addition, in the certificate, the artist name, the title, the catalog number, the label name, the number of analog records, other special notes (a strap, the color of the disk, the shape of the label, and the like), and the like may be included. Note that items included in the certificate may be provided in accordance with real-world needs.

The server 1 allocates the certificate ID for identifying the certificate to the created certificate. The server 1 stores the management number of the analog record, and the data and the appraisal date of the certificate in the certificate DB 172, as one record, in association with the allocated certificate ID.

In a case where the user purchases the analog record, the server 1 acquires the certificate corresponding to the analog record from the certificate DB 172, on the basis of the management number of the purchased analog record. The server 1 transmits the acquired certificate to the user terminal 2 of a target user. The user terminal 2 receives the certificate transmitted from the server 1 and displays the certificate on a screen. Note that the certificate for the analog record may be printed on paper and may be sent to the user by mail or the like. Alternatively, the certificate for the analog record printed on paper may be directly delivered to the user by hand.

Note that the server 1 may transmit a code in which the certificate ID is described to the user terminal 2. The server 1 reads the code by the user terminal 2 to transmit the certificate to the user terminal 2.

The code, for example, is a two-dimensional code, a one-dimensional code, or the like. The two-dimensional code is a code in a display mode that has information in a horizontal direction and a perpendicular direction, whereas the one-dimensional code has information only in a traverse direction. The typical two-dimensional code, for example, is a QR code (registered trademark), DataMatrix (registered trademark), or VeriCode (registered trademark). The one-dimensional code, for example, is a bar code. In this embodiment, as an example, it is described that the QR code is read.

The server 1 generates a QR code including the certificate ID by using a two-dimensional code-generated library. The server 1 transmits the generated QR code to the user terminal 2. The user terminal 2 receives the QR code transmitted from the server 1. The user terminal 2 reads the received QR code through the photographing unit 26 to acquire the certificate ID included in the QR code. The user terminal 2 transmits the acquired certificate ID to the server 1.

The server 1 receives the certificate ID transmitted from the user terminal 2. The server 1 acquires the certificate for the analog record from the certificate DB 172, on the basis of the received certificate ID. The server 1 transmits the acquired certificate to the user terminal 2. The user terminal 2 receives the certificate transmitted from the server 1 and displays the certificate on the screen.

FIG. 6 is an explanatory diagram illustrating an example of a display screen of the certificate. The display screen of the certificate includes a jacket image display section 11a, a first appraisal information display section 11b, a second appraisal information display section 11c, and a matrix number image display section 11d. The jacket image display section 11a is a display section displaying the jacket image or the thumbnail image of the jacket. The first appraisal information display section 11b is a display section displaying first appraisal information. The second appraisal information display section 11c is a display section displaying second appraisal information. The matrix number image display section 11d is a display section displaying the image data of the matrix number.

The user terminal 2 reads in the QR code including the certificate ID to acquire the certificate ID. The user terminal 2 transmits the acquired certificate ID to the server 1. The server 1 receives the certificate ID transmitted from the user terminal 2. The server 1 acquires the management number of the analog record corresponding to the certificate from the certificate DB 172, on the basis of the received certificate ID.

The server 1 acquires the appraisal information and the purchase date of the analog record from the appraisal information DB 171, on the basis of the acquired management number of the analog record. The appraisal information includes the artist name, the title, the catalog number, the label name, and the jacket image of the analog record, the size of the jacket, the weight, the production year, the matrix number, and the information indicating the initial matrix number of the analog record, the image data of the matrix number, and the like. The server 1 transmits the acquired appraisal information to the user terminal 2, in association with the management number of the analog record.

The user terminal 2 receives the management number and the appraisal information of the analog record transmitted from the server 1, and displays the received management number and appraisal information on the screen. Specifically, the user terminal 2 displays the jacket image included in the appraisal information in the jacket image display section 11a. Note that in FIG. 6, an example has been described in which the jacket image is displayed on the screen, but the present invention is not limited thereto. For example, the label image may be displayed on the screen, or both of the jacket image and the label image may be displayed on the screen.

The user terminal 2 displays the artist name, the title, the catalog number, the label name, the matrix number, the production year, the size of the jacket, the weight and the purchase date of the analog record, and the management number of the analog record, which are included in the appraisal information, in the first appraisal information display section 11b. The user terminal 2 displays the information indicating the initial matrix number, which is included in the appraisal information, in the second appraisal information display section 11c. The user terminal 2 displays the image data of the matrix number, which is included in the appraisal information, in the matrix number image display section 11d.

FIG. 7 is a flowchart illustrating a processing procedure when outputting the certificate. The control unit 11 of the server 1 acquires the appraisal information of the analog record and the purchase date of the analog record by the input unit 14 (step S101).

The control unit 11 stores the acquired appraisal information and purchase date in the appraisal information DB 171 of the high-capacity storage unit 17 (step S102). Specifically, the control unit 11 allocates the management number to the acquired appraisal information. The control unit 11 stores the artist name, the title, the weight, the production year, the matrix number, the information indicating the initial matrix number, the image data of the matrix number, the catalog number, the label name, the label image, the jacket image, the size of the jacket, and the purchase date in the appraisal information DB 171, as one record, in association with the allocated management number.

The control unit 11 creates the certificate for the analog record, on the basis of the appraisal information (step S103). The control unit 11 stores the created certificate in the certificate DB 172 of the high-capacity storage unit 17 (step S104). Specifically, the control unit 11 allocates the certificate ID to the created certificate. The control unit 11 stores the management number of the analog record, and the data and the appraisal date of the certificate in the certificate DB 172, as one record, in association with the allocated certificate ID.

Note that in a case where the processing (steps S101 to S104) described above is executed once, the execution of the processing can be omitted from the next time.

The control unit 11 generates the QR code including the certificate ID by using the two-dimensional code-generated library (step S105). The control unit 11 transmits the generated QR code to the user terminal 2 by the communication unit 13 (step S106).

The control unit 21 of the user terminal 2 receives the QR code transmitted from the server 1 by the communication unit 23 (step S201). The control unit 21 reads the received QR code through the photographing unit 26 (step S202), and acquires the certificate ID included in the QR code (step S203). The control unit 21 transmits the acquired certificate ID to the server 1 by the communication unit 23 (step S204).

The control unit 11 of the server 1 receives the certificate ID transmitted from the user terminal 2 by the communication unit 13 (step S107). The control unit 11 acquires the certificate for the analog record from the certificate DB 172 of the high-capacity storage unit 17, on the basis of the received certificate ID (step S108). In the certificate, for example, the artist name, the title, the catalog number, and the label name are included.

The control unit 11 transmits the acquired certificate for the analog record to the user terminal 2 by the communication unit 13 (step S109). For example, the control unit 11 may transmit the data of the certificate to the user terminal 2 through the communication unit 13, or may transmit a PDF file or the like in which the contents of the certificate are described to the user terminal 2.

The control unit 21 of the user terminal 2 receives the certificate transmitted from the server 1 by the communication unit 23 (step S205). The control unit 21 displays the received certificate by the display unit 25 (step S206), and ends the processing.

Subsequently, processing of storing the information relevant to the user (user information) in a case where the user purchases the analog record will be described.

FIG. 8 is a flowchart illustrating a processing procedure when storing the user information of the user who purchases the analog record. The control unit 21 of the user terminal 2, for example, accepts a purchase instruction of the analog record by the input unit 24 through a purchase screen of the analog record (not illustrated) (step S211). The control unit 21, for example, performs payment processing on the analog record to be a purchase target through a payment system or a platform (step S212).

The control unit 21 transmits the user information of the user who purchases the analog record and purchase information to the server 1 by the communication unit 23 (step S213). The user information includes the name, the gender, or the like of the user. The purchase information includes the management number, the purchase price, the purchase date and time, or the like of the purchased analog record. The control unit 11 of the server 1 receives the user information and the purchase information transmitted from the user terminal 2 by the communication unit 13 (step S111).

The control unit 11 acquires the certificate ID and the certificate (the data of the certificate) for the analog record from the certificate DB 172 of the high-capacity storage unit 17, on the basis of the management number of the analog record included in the received purchase information (step S112). Note that in a case where the certificate for the analog record is not created, the control unit 11 may create the certificate as with the certificate creation processing of steps S101 to S104 in FIG. 7.

The control unit 11 stores the received user information in the user DB 173 of the high-capacity storage unit 17 (step S113). Specifically, the control unit 11 allocates the user ID to the user information. The control unit 11 stores the name and the gender of the user in the user DB 173, as one record, in association with the allocated user ID.

The control unit 11 stores the purchase information in the purchase DB 174 of the high-capacity storage unit 17, in association with the acquired certificate ID (step S114). Specifically, the control unit 11 stores the management number, the purchase price, and the purchase date and time of the analog record in the purchase DB 174, as one record, in association with the user ID and the certificate ID.

The control unit 11 transmits the acquired certificate for the analog record to the user terminal 2 by the communication unit 13 (step S115). The control unit 21 of the user terminal 2 receives the certificate transmitted from the server 1 by the communication unit 23 (step S214). The control unit 21 displays the received certificate by the display unit 25 (step S215), and ends the processing.

According to this embodiment, it is possible to output the certificate for the analog record, on the basis of the appraisal information of the analog record.

According to this embodiment, by the user terminal 2 reading the code in which the certificate ID is described, it is possible to output the certificate for the analog record to the user terminal 2.

According to this embodiment, in a case where the user purchases the analog record, it is possible to store the information relevant to the user.

### Embodiment 2

Embodiment 2 relates to a configuration in which a certificate non-fungible token (NFT) corresponding to the certificate for the analog record is issued on a blockchain system. Note that the description of the contents overlapping with those in Embodiment 1 will be omitted.

NFT is digital data with a certificate or a possession certificate, and is a mechanism in which a blockchain technology is used for data management, as with a virtual currency, and a falsification is not available. The certificate NFT is issued on the blockchain system, and is certification of having possessive rights for the certificate by associating the certificate for the analog record with NFT.

FIG. 9 is an explanatory diagram illustrating the outline of a certificate issue system in Embodiment 2. Note that the same reference numerals will be applied to the contents overlapping with those in FIG. 1, and the description will be omitted. The system of this embodiment further includes a blockchain system 3.

The blockchain system 3 is a distributed ledger technology or a distributed network. The blockchain system 3 is composed of a plurality of nodes 31 executing consensus processing. Each of the nodes 31 retains the copy of blockchain data by executing the consensus processing. The blockchain system 3 generates the unit of data, which is referred to as a block, at regular intervals, and stores data by linking the data into the form of a chain.

The blockchain system 3 is autonomically managed by using a peer-to-peer network and a distributed time stamp server. The data is stored in the form of a chain, and thus, in a case where the data in the block is once stored, it is difficult to retroactively change the data. Note that the blockchain system 3 may be any of a public type, a private type, and a consortium type. The unit of the data may be an individual transaction instead of the block. In addition, the storage of the data may be in a storage format such as a directed acyclic graph, in addition to the form of a chain. Hereinafter, for simplicity, the blockchain system 3 will be referred to as the blockchain 3.

FIG. 10 is a block diagram illustrating a configuration example of the node 31 of the blockchain 3. The node 31 of the blockchain 3 includes a control unit 311, a storage unit 312, a communication unit 313, an acceptance unit 314, an output unit 315, a block generation unit 316, a block verification unit 317, and a block sharing unit 318. Each configuration is connected by a bus B.

The control unit 311 cooperates with the control unit of another node 31 (terminal) in an autonomous and distributed manner, and constantly retains the latest blockchain (the ledger: the copy of the blockchain data) in the storage unit 312. In the storage unit 312, a blockchain (a ledger) in which a transaction broadcast to the distributed network, information required for verification processing of information in the block, and the like are stored.

The communication unit 313 is a communication module for performing processing relevant to communication. The acceptance unit 314 accepts information to be recorded in the distributed network that is the blockchain 3 managed by the blockchain 3 from an external node. The output unit 315 outputs the information of the blockchain 3 retained by the output unit, in accordance with a request from the external node.

The block generation unit 316 generates a block to be added to the blockchain 3, on the basis of the information accepted by the acceptance unit 314. The block generation unit 316 generates a block including information based on the previous block and the information accepted by the acceptance unit 314. In addition, the block generation unit 316 performs, as predetermined consensus processing, for example, processing of searching for a nonce or processing of giving a signature on the block generated by the block generation unit or the block generated by another node 31 through the block sharing unit 318 described below, and then, adds the block to the blockchain 3 managed by the block generation unit. Note that the block generated by the block generation unit 316 is subjected to the predetermined consensus processing by the plurality of nodes 31, which is the block finally added to the blockchain 3.

The block verification unit 317 performs the verification of the information in the block when adding the block to the blockchain 3 retained by the block verification unit. In general, the block to be an addition target is a block in which a rule is satisfied most quickly in a group of nodes 31 including the own node 31, but whether the rule is actually satisfied may be verified in consideration of a case where a malicious node 31 is included.

The block sharing unit 318 performs information exchange with respect to the node 31 belonging to the blockchain 3. More specifically, the block sharing unit 318 suitably transmits the information accepted by the acceptance unit 314, the block generated by the block generation unit 316, the block accepted from another node 31, and the like to another node 31. Accordingly, the information and the latest blockchain 3 are shared by all the nodes 31 wherever possible.

Note that the configuration of FIG. 10 is merely an example, and the specific configuration of the node 31 of the blockchain 3 is not important insofar as the node is capable of performing the predetermined consensus processing for the plurality of nodes to share and manage the blockchain 3 for which a falsification is not available, and is capable of adding the information to the distributed network in accordance with the request from the external node and referring to the information recorded in the distributed network.

Note that the server 1 may be the node 31 of the blockchain 3.

FIG. 11 is an explanatory diagram illustrating an example of the record layout of the certificate DB 172 in Embodiment 2. Note that the same reference numerals will be applied to the contents overlapping with those in FIG. 3, and the description will be omitted. The certificate DB 172 includes a certificate NFT column and a user ID column.

In the certificate NFT column, the certificate NFT issued on the blockchain 3 is stored. For example, on the blockchain 3, ERC721 that is one smart contract standard of Ethereum may be used to issue a certificate NFT capable of certifying “authenticity” or “value” as with the certificate or the like. In a case where ERC721 is used, in the certificate NFT, a token ID, a possessor address, a token uniform resource identifier (URI), and the like are included.

For example, in the certificate NFT column, an index on the blockchain 3 including the token ID, the possessor address, the token URI, and the like of the certificate NFT is stored. Note that the token ID, the possessor address, the token URI, and the like of the certificate NFT are stored on the blockchain 3 when issuing the certificate NFT. The token URI is attribute indicating the location of metadata with respect to the certificate NFT. The location of the metadata, for example, is the uniform resource locator (URL) or the like of the metadata (an image, a moving image, or the like). Note that the metadata itself, for example, may be stored in an external database device in the format of javascript object notation (JSON).

In the user ID column, the user ID for specifying the user (a possessor) is stored.

FIG. 12 is an explanatory diagram illustrating processing of issuing the certificate NFT. The user terminal 2 transmits the management number of the analog record to be the purchase target to the server 1, in association with the user ID. The server 1 receives the user ID and the management number transmitted from the user terminal 2. The server 1 acquires the appraisal information of the analog record from the appraisal information DB 171, in accordance with the received management number of the analog record.

The server 1 calculates the hash value of the acquired appraisal information by using a cryptographic hash function. For example, the server 1 adopts a hash function using an SHA2-256 algorithm, and calculates the hash value of the appraisal information. Note that other encryption methods may be used without being limited to the hash function. The server 1 acquires the certificate ID of the analog record from the certificate DB 172, on the basis of the management number of the analog record.

The server 1 transmits the calculated hash value of the appraisal information to any node 31 of the blockchain 3, in association with the acquired certificate ID. The node 31 of the blockchain 3 receives and records the certificate ID and the hash value of the appraisal information transmitted from the server 1.

The server 1 generates (issues) the certificate NFT on the blockchain 3 through the blockchain 3. For example, in a case where the blockchain 3 is Ethereum, the server 1 generates the certificate NFT by using ERC721 that is one smart contract standard of Ethereum.

All the certificate NFTs on the blockchain 3 are disclosed by using the ERC721 standard, but a falsification is not available, and thus, the possessor, ascriptive information, or the like can be applied. The token ID, the possessor address, the token URI, and the like of the generated certificate NFT are stored on the blockchain 3.

Note that in a case where the certificate NFT is issued to an administrator, the administrator transfers the certificate NFT that the administrator possesses to the target user. In this case, the blockchain 3 takes over the token ID and the token URI (the location of the metadata) of the certificate NFT. The blockchain 3 changes the possessor address of the certificate NFT from the possessor address of the administrator to the possessor address of the target user. The blockchain 3 records the token ID (no change), the changed possessor address, the token URI (no change), and the like of the transferred certificate NFT.

In addition, the possessor (the user) of the certificate NFT is capable of freely transacting the certificate NFT as with crypto-asset by buying and selling or transferring the certificate NFT.

The server 1 stores the certificate NFT (the token ID, the possessor address, the token URI, or the like) generated on the blockchain 3 in the certificate DB 172, in association with the certificate ID and the user ID.

The server 1 acquires the certificate (the data of the certificate), on the basis of the certificate ID. Specifically, the server 1 acquires the management number of the analog record in the certificate from the certificate DB 172, on the basis of the certificate ID. The server 1 acquires the appraisal information of the analog record from the appraisal information DB 171, on the basis of the acquired management number. The server 1 calculates the hash value of the acquired appraisal information by using the cryptographic hash function. The server 1 acquires the hash value of the appraisal information recorded on the blockchain 3 from the node 31 of the blockchain 3, on the basis of the certificate ID. The server 1 compares the calculated hash value of the appraisal information with the hash value of the appraisal information acquired from the blockchain 3. In a case where it is determined that both of the hash values are coincident with each other, the server 1 acquires the certificate stored in the certificate DB 172, on the basis of the certificate ID.

The server 1 transmits the certificate NFT issued on the blockchain 3, and the acquired certificate to the user terminal 2. The user terminal 2 receives the certificate NFT and the certificate transmitted from the server 1, and displays the certificate NFT and the certificate on the screen.

FIG. 13 is a flowchart illustrating a processing procedure when issuing the certificate NFT. The control unit 21 of the user terminal 2 transmits the management number of the analog record to be the purchase target to the server 1 through the communication unit 23, in association with the user ID (step S221). The control unit 11 of the server 1 receives the user ID and the management number transmitted from the user terminal 2 by the communication unit 13 (step S121).

The control unit 11 of the server 1 acquires the appraisal information of the analog record from the appraisal information DB 171 of the high-capacity storage unit 17, in accordance with the received management number of the analog record (step S122). The appraisal information includes the artist name, the title, the catalog number, the label name, the label image, and the jacket image of the analog record, the size of the jacket, the weight, the production year, the matrix number, and the information indicating the initial matrix number of the analog record, the image data of the matrix number, and the like.

The control unit 11 calculates the hash value of the acquired appraisal information by using the cryptographic hash function (step S123). The control unit 11 acquires the certificate ID of the analog record from the certificate DB 172 of the high-capacity storage unit 17, on the basis of the management number of the analog record (step S124). The control unit 11 transmits the certificate ID and the hash value of the appraisal information to any node 31 of the blockchain 3 through the communication unit 13 (step S125).

The control unit 311 of the node 31 of the blockchain 3 receives the certificate ID and the hash value of the appraisal information transmitted from the server 1 through the communication unit 313 (step S321). The control unit 311 of the node 31 records the hash value of the appraisal information in the storage unit 312, in association with the received certificate ID (step S322).

The control unit 311 of the node 31, for example, generates the certificate NFT by using ERC721 (S323). The control unit 311 records the token ID, the possessor address, and the token URI of the generated certificate NFT in the storage unit 312 (step S324). The control unit 311 transmits the generated certificate NFT to the server 1 by the communication unit 313 (step S325).

The control unit 11 of the server 1 receives the certificate NFT transmitted from the node 31 of the blockchain 3 by the communication unit 13 (step S126). The control unit 11 stores the certificate NFT including the token ID, the possessor address, the token URI, or the like in the certificate DB 172 of the high-capacity storage unit 17, in association with the certificate ID and the user ID (step S127).

The control unit 11 acquires the certificate, on the basis of the certificate ID (step S128). Specifically, the control unit 11 acquires the management number of the analog record in the certificate from the certificate DB 172 of the high-capacity storage unit 17, on the basis of the certificate ID. The control unit 11 acquires the appraisal information of the analog record from the appraisal information DB 171, on the basis of the acquired management number. The control unit 11 calculates the hash value of the acquired appraisal information by using the cryptographic hash function.

The control unit 11 acquires the hash value of the appraisal information recorded on the blockchain 3 from the node 31 of the blockchain 3 by the communication unit 13, on the basis of the certificate ID. The control unit 11 compares the calculated hash value of the appraisal information with the hash value of the appraisal information acquired from the blockchain 3. In a case where it is determined that both of the hash values are coincident with each other, the control unit 11 acquires the certificate stored in the certificate DB 172 of the high-capacity storage unit 17, on the basis of the certificate ID.

The control unit 11 transmits the certificate NFT issued on the blockchain 3, and the acquired certificate to the user terminal 2 by the communication unit 13 (step S129). The control unit 21 of the user terminal 2 receives the certificate NFT and the certificate transmitted from the server 1 by the communication unit 23 (step S222). The control unit 21 displays the received certificate NFT and certificate by the display unit 25 (step S223), and ends the processing.

Note that in this embodiment, the node 31 of the blockchain 3 transmits the issued certificate NFT to the user terminal 2 through the server 1, but the present invention is not limited thereto. For example, the node 31 of the blockchain 3 may directly transmit the issued certificate NFT to the user terminal 2.

Subsequently, processing of outputting information relevant to the artist of the analog record corresponding to the certificate in the certificate NFT, or a content relevant to music included in the analog record to the user terminal 2 will be described.

The information relevant to the artist includes the artist name, the gender, the age, the artwork of the artist, or the like. The information relevant to the artist or the content relevant to the music included in the analog record may be stored in the storage unit 12 or the high-capacity storage unit 17 of the server 1, or may be stored in an external database device. By providing the information relevant to the artist or the content relevant to the music included in the analog record to the user who possesses the certificate NFT, it is possible to add a utility value other than the certification of possessing the certificate NFT.

FIG. 14 is an explanatory diagram illustrating an example of a list screen of the certificate NFT. The screen includes a certificate NFT display section 12a and a display button 12b. The certificate NFT display section 12a is a display section displaying the jacket image of the analog record, the token ID and the token URI of the certificate NFT, and the like. The display button 12b is a button for transitioning to the display screen (FIG. 6) of the certificate corresponding to the certificate NFT.

The user terminal 2 acquires all the certificate NFTs possessed by the user from the node 31 of the blockchain 3 using a crypto wallet of the user. In the acquired certificate NFT, the token ID, the possessor address, the token URI (the location of the metadata), and the like are included. The token URI, for example, includes the URL of the information relevant to the artist of the analog record corresponding to the certificate in the certificate NFT, the URL of the content relevant to the music included in the analog record, or the like.

The user terminal 2 transmits the token ID of each of the acquired certificate NFTs to the server 1. The server 1 acquires the management number of the analog record in the certificate corresponding to each of the certificate NFTs from the certificate DB 172, on the basis of the token ID of each of the certificate NFTs transmitted from the user terminal 2. The server 1 acquires the jacket image of each of the analog records from the appraisal information DB 171, on the basis of the acquired management number of each of the analog records. The server 1 transmits the acquired jacket image of each of the analog records to the user terminal 2.

The user terminal 2 displays the jacket image of each of the analog records transmitted from the server 1 in the certificate NFT display section 12a, in association with the token ID and the token URI of each of the certificate NFTs (for example, the URL of the information relevant to the artist and the URL of the content relevant to the music) acquired from the node 31 of the blockchain 3.

In a case where a linking manipulation of the URL of the information relevant to the artist is accepted, the user terminal 2 acquires and displays the information relevant to the artist posted on a site designated by the URL. In a case where the linking manipulation of the URL of the content relevant to the music is accepted, the user terminal 2 acquires and displays the content relevant to the music posted on a site designated by the URL.

Note that in this embodiment, an example has been described in which a benefit of enabling the information relevant to the artist or the content relevant to the music to be browsed is given to the certificate NFT, but the present invention is not limited thereto. For example, a benefit of delivering and browsing a content such as a moving image or an image relevant to the analog record, applying a discount when purchasing the related product, participating in a specific event, rewarding points, or receiving special goods (for example, a book, a magazine, or a gift card) may be given to the certificate NFT.

In a case where a touch manipulation of the display button 12b is accepted, the user terminal 2 transitions to the display screen (FIG. 6) of the certificate corresponding to the certificate NFT. Specifically, the user terminal 2 transmits the token ID of the certificate NFT to the server 1. The server 1 acquires the certificate ID of the certificate corresponding to the certificate NFT, and the management number of the analog record in the certificate from the certificate DB 172, on the basis of the token ID of the certificate NFT transmitted from the user terminal 2.

The server 1 acquires the appraisal information of the analog record from the appraisal information DB 171, on the basis of the acquired management number. The server 1 calculates the hash value of the acquired appraisal information by using the cryptographic hash function. The server 1 acquires the hash value of the appraisal information recorded on the blockchain 3 from the node 31 of the blockchain 3, on the basis of the acquired certificate ID. The server 1 compares the calculated hash value of the appraisal information with the hash value of the appraisal information acquired from the blockchain 3.

In a case where it is determined that both of the hash values are coincident with each other, the server 1 acquires the certificate (the data of the certificate) stored in the certificate DB 172, on the basis of the certificate ID. The server 1 generates the display screen (FIG. 6) of the acquired certificate, and transmits the generated display screen of the certificate to the user terminal 2. The user terminal 2 transitions to the display screen of the certificate transmitted from the server 1.

FIG. 15 is a flowchart illustrating a processing procedure when outputting the information relevant to the artist and the content. The control unit 21 of the user terminal 2 acquires all the certificate NFTs possessed by the user from the node 31 of the blockchain 3 through the communication unit 23 using the crypto wallet of the user (step S231). In each of the certificate NFTs, the token ID, the possessor address, the token URI, and the like are included. The token URI, for example, includes the URL of the information relevant to the artist of the analog record, the URL of the content relevant to the music included in the analog record, or the like.

The control unit 21 displays each of the acquired certificate NFTs in the form of a list through the display unit 25 (step S232). In a case where the selection of the certificate NFT to be a target is accepted by the input unit 24 (step S233), the control unit 21 transmits the user ID and the token ID of the selected certificate NFT to the server 1 by the communication unit 23 (step S234). The control unit 11 of the server 1 receives the user ID and the token ID of the certificate NFT transmitted from the user terminal 2 by the communication unit 13 (step S131).

The control unit 11 acquires the appraisal information of the analog record in the certificate corresponding to the certificate NFT, on the basis of the received token ID of the certificate NFT (step S132). Specifically, the control unit 11 acquires the management number of the analog record in the certificate corresponding to the certificate NFT from the certificate DB 172 of the high-capacity storage unit 17, on the basis of the token ID of the certificate NFT. The control unit 11 acquires the appraisal information of the analog record from the appraisal information DB 171 of the high-capacity storage unit 17, on the basis of the acquired management number.

The control unit 11 calculates the hash value of the acquired appraisal information by using the cryptographic hash function (step S133). The control unit 11 acquires the hash value of the appraisal information recorded on the blockchain 3 from the node 31 of the blockchain 3 by the communication unit 13, on the basis of the certificate ID of the certificate corresponding to the certificate NFT (step S134). The control unit 11 determines whether the calculated hash value of the appraisal information is coincident with the hash value of the appraisal information acquired from the node 31 of the blockchain 3 (step S135).

In a case where it is determined that both of the hash values are not coincident with each other it is determined that (NO in step S135), the control unit 11 ends the processing. Note that the control unit 11 may transmit an error message indicating that the acquisition of the certificate fails to the user terminal 2 by the communication unit 13. In a case where both of the hash values are coincident with each other it is determined that (YES in step S135), the control unit 11 acquires the certificate (the data of the certificate) from the certificate DB 172 of the high-capacity storage unit 17, on the basis of the certificate ID (step S136). The control unit 11 transmits the acquired certificate to the user terminal 2 by the communication unit 13 (step S137).

The control unit 21 of the user terminal 2 receives the certificate transmitted from the server 1 by the communication unit 23 (step S235). The control unit 21 displays the received certificate by the display unit 25 (step S236). The control unit 21 accepts the linking manipulation of the URL of the information relevant to the artist or the URL of the content relevant to the music by the input unit 24 (step S237). The control unit 21 acquires the information relevant to the artist or the content relevant to the music posted on the site designated by the URL by the communication unit 23, in accordance with the accepted linking manipulation of the URL (step S238).

The control unit 21 displays the acquired information relevant to the artist or content relevant to the music by the display unit 25 (step S239), and ends the processing. Note that in this embodiment, an example has been described in which the user terminal 2 directly acquires the information relevant to the artist or the content relevant to the music, but the present invention is not limited thereto. For example, the user terminal 2 may acquire the information relevant to the artist or the content through the server 1.

According to this embodiment, it is possible to generate the certificate NFT corresponding to the certificate for the analog record on the blockchain 3.

According to this embodiment, it is possible to issue the certificate NFT corresponding to the certificate for the analog record to the user who purchases the analog record.

According to this embodiment, it is possible to output the information relevant to the artist of the analog record corresponding to the certificate in the certificate NFT, or the content relevant to the music included in the analog record to the user terminal 2.

### Embodiment 3

Embodiment 3 relates to a configuration in which the certificate NFT is transferred. Note that the description of the contents overlapping with those in Embodiments 1 and 2 will be omitted.

The possessor who possesses the analog record is capable of transferring the analog record to another person. In addition, the possessor is capable of transferring the certificate NFT corresponding to the certificate for the analog record on the blockchain 3, together with the analog record.

For example, in a case where a first entity transfers the certificate NFT that the first entity possesses to a first user on the blockchain 3, possessive rights for the certificate NFT are transferred from the first entity to the first user. After that, in a case where the first user transfers the certificate NFT to a second entity different from the first entity on the blockchain 3, the possessive rights for the certificate NFT are transferred from the first user to the second entity. The entity, for example, includes a shop for selling the analog record, an electronic commerce (EC) site, a company-operated store, a company, or the like.

FIG. 16 is a block diagram illustrating a configuration example of the server 1 in Embodiment 3. Note that the same reference numerals will be applied to the contents overlapping with those in FIG. 2, and the description will be omitted. In the high-capacity storage unit 17, a transfer DB 175 and an authorized person DB 178 are stored. In the transfer DB 175, information relevant to the transfer of the certificate NFT is stored. In the authorized person DB 178, information relevant to an authorized person who gives an incentive is stored. Note that the authorized person will be described below.

FIG. 17 is an explanatory diagram illustrating an example of the record layout of the transfer DB 175 and the authorized person DB 178.

The transfer DB 175 includes a certificate ID column, a management number column, a transfer source column, a transfer destination column, and a transfer date and time column. In the certificate ID column, the certificate ID for specifying the certificate for the analog record is stored. In the management number column, the management number of the analog record is stored.

The transfer source column includes a user ID column and a possessor address column. In the user ID column, the user ID of a transfer source is stored. In the possessor address column, the possessor address of the certificate NFT of the transfer source is stored. The transfer destination column includes a user ID column and a possessor address column. In the user ID column, the user ID of a transfer destination is stored. In the possessor address column, the possessor address of the certificate NFT of the transfer destination is stored. In the transfer date and time column, the information of the date and time when the certificate NFT is transferred is stored.

The authorized person DB 178 includes a certificate ID column, a management number column, an authorized person ID column, an authorized person type column, and a wallet address column. In the certificate ID column, the certificate ID for specifying the certificate for the analog record is stored. In the management number column, the management number of the analog record is stored. In the authorized person ID column, an authorized person ID for specifying the authorized person is stored. Note that in the authorized person ID column, the name of the authorized person may be stored.

In the authorized person type column, the type of authorized person is stored. The type of authorized person includes the copyright holder of the analog record, the possessor (the user) of the analog record, or an artist, a player, a business, a label specialized for an analog record, an art director, or a photographer relevant to the analog record, and the like. Note that the type of authorized person is not limited to the types described above, and for example, may include the manufacturer of the analog record, the bereaved family of the artist, or the like. In the wallet address column, the wallet address of the authorized person is stored.

FIG. 18 is an explanatory diagram illustrating processing of transferring the certificate NFT. Note that in FIG. 18, an example will be described in which the blockchain 3 is Ethereum, but the same can be applied to other types of blockchains 3.

The server 1, for example, generates the certificate NFT corresponding to the certificate for the analog record that the first entity possesses on the blockchain 3 by using ERC721. The token ID, the possessor address of the first entity (hereinafter, will be referred to as a first entity address), the token URI, and the like of the generated certificate NFT are stored on the blockchain 3. In addition, the server 1 stores the token ID, the first entity address, the token URI, and the like of the certificate NFT in the certificate DB 172, in association with the user ID and the certificate ID of the first entity.

In a case where the first entity that possesses the analog record transfers the analog record to the first user, processing of transferring the certificate NFT corresponding to the certificate for the analog record from the first entity to the first user is performed on the blockchain 3.

Specifically, in a case where the server 1 accepts a transfer instruction for transferring the certificate NFT that the first entity possesses to the first user, a transaction for transferring the certificate NFT from the first entity to the first user is created. The transaction is a transaction record in the blockchain 3, in which various types of information and the transfer of the value between the participants of the blockchain 3 are stored. The created transaction includes the token ID of the certificate NFT, the first entity address, the possessor address of the first user (hereinafter, will be referred to as a first user address), a transaction date and time, and the like.

The server 1 transmits the created transaction to any node 31 of the blockchain 3. The node 31 of the blockchain 3 receives the transaction transmitted from the server 1. The node 31 executes the transfer processing of the certificate NFT to be the target, in accordance with the received transaction.

Specifically, the node 31 takes over the token ID and the token URI (the location of the metadata) of the certificate NFT. The node 31 changes the possessor address of the certificate NFT from the first entity address to the first user address. The node 31 records the token ID (no change), the changed possessor address, the token URI (no change), and the like of the transferred certificate NFT.

The node 31 of the blockchain 3 transmits the certificate NFT transferred from the first entity to the first user to the server 1. The server 1 receives the transferred certificate NFT transmitted from the node 31 of the blockchain 3. The server 1 updates the transferred certificate NFT, and the user ID of the first user to be the transfer destination in the certificate DB 172, on the basis of the certificate ID.

The server 1 stores transfer information in the transfer DB 175, in association with the certificate ID. Specifically, the server 1 stores a transfer date and time, the user ID and the possessor address of the first entity (the transfer source), and the user ID and the possessor address of the first user (the transfer destination) in the transfer DB 175, as one record, in association with the certificate ID and the management number of the analog record.

In a case where the analog record that the first entity possesses is transferred from the first entity to the first user by the processing described above, the certificate NFT corresponding to the certificate for the analog record is transferred from the first entity to the first user. Accordingly, the first user possesses the analog record and the certificate NFT corresponding to the certificate for the analog record. In addition, the first user is capable of further transferring the analog record and the certificate NFT corresponding to the certificate for the analog record to the second entity. Note that processing of transferring the analog record and the certificate NFT from the first user to the second entity is the same as the transfer processing described above, and thus, the description will be omitted.

Note that in this embodiment, an example has been described in which both of the analog record and the certificate NFT are transferred, but the present invention is not limited thereto. For example, only the analog record may be transferred, or only the certificate NFT corresponding to the certificate for the analog record may be transferred.

FIG. 19 is a flowchart illustrating a processing procedure when transferring the certificate NFT. The control unit 11 of the server 1 acquires the transfer instruction of the certificate NFT from the user terminal 2 through the communication unit 13 (step S141). Note that the control unit 11 may directly accept the transfer instruction of the certificate NFT by the input unit 14. The control unit 11 creates the transaction for transferring the certificate NFT, in accordance with the acquired transfer instruction (step S142). The transaction includes the token ID of the certificate NFT, the possessor address of the transfer source, the possessor address of the transfer destination, the transaction date and time, and the like.

The control unit 11 transmits the created transaction to any node 31 of the blockchain 3 through the communication unit 13 (step S143). The control unit 311 of the node 31 of the blockchain 3 receives the transaction transmitted from the server 1 by the communication unit 313 (step S341).

The control unit 311 of the node 31 executes the transfer processing of the certificate NFT to be the target, in accordance with the received transaction (step S342). Specifically, the control unit 311 takes over the token ID and the token URI of the certificate NFT. The control unit 311 changes the possessor address of the certificate NFT from the possessor address of the transfer source to the possessor address of the transfer destination. The control unit 311 of the node 31 records the token ID, the possessor address (the transfer destination), the token URI, and the like of the transferred certificate NFT.

The control unit 311 of the node 31 transmits the transferred certificate NFT to the server 1 by the communication unit 313 (step S343). The control unit 11 of the server 1 receives the transferred certificate NFT transmitted from the node 31 by the communication unit 13 (step S144). The control unit 11 updates the transferred certificate NFT and the user ID of the transfer destination in the certificate DB 172 of the high-capacity storage unit 17, on the basis of the certificate ID (step S145).

The control unit 11 stores the transfer information in the transfer DB 175 of the high-capacity storage unit 17, in association with the certificate ID (step S146), and ends the processing. The transfer information includes the management number of the analog record, transfer source information (the user ID and the possessor address of the transfer source), transfer destination information (the user ID and the possessor address of the transfer destination), and the transfer date and time.

Subsequently, processing of giving an incentive to the authorized person of the analog record corresponding to the certificate in the certificate NFT by transferring the certificate NFT will be described. Note that hereinafter, an example will be described in which the authorized person is the artist, but the same can be applied to other types of authorized persons.

FIG. 20 is an explanatory diagram illustrating processing of giving an incentive to the artist by a smart contract. It is possible to transfer the certificate NFT from a possessor A who possesses the certificate NFT to a possessor B. In a case where the certificate NFT is transferred from the possessor A to the possessor B, the address of the possessor A is changed to the address of the possessor B on ERC721, and thus, the transfer of the certificate NFT is completed.

By the smart contract for giving an incentive to the artist of the analog record corresponding to the certificate in the certificate NFT, in accordance with the transfer of the certificate NFT, an incentive is given to the artist.

The smart contract is a mechanism in which the definition of an execution condition and contract contents is programmed and incorporated in advance in the transaction, and the contract is automatically executed when there is a transaction coincident with the execution condition and the contract contents. The incentive is information according to a value for which a legal currency, a virtual currency (crypto-asset), electronic money, a coupon, a point, or the like can be used. Note that hereinafter, an example will be described in which the incentive is the virtual currency, but the same can be applied to incentives in other formats.

The server 1 generates the code of the smart contract in which the execution condition, the contract contents, the wallet address of the artist, and the like, required for performing the processing of giving an incentive to the artist are described. The server 1 records in advance the transaction including the generated code of the smart contract in the blockchain 3.

In this embodiment, in the contents of the code of the smart contract, a contract for giving a virtual currency calculated by a predetermined standard to the wallet address of the artist when the certificate NFT is transferred is defined in a code. Note that in this embodiment, the single smart contract is included in a single transaction, but the present invention is not limited thereto. For example, a plurality of linked smart contracts may be included in a single or plurality of transactions.

As illustrated, the transaction includes the code of the smart contract, the token ID of the certificate NFT, a transfer expense, the transfer destination, and the electronic signature of the artist. In a case where the transaction is coincident with the execution condition relevant to the transfer of the certificate NFT, the blockchain 3 gives the amount of virtual currencies determined on the contract contents from the wallet address of the transfer destination (the possessor B) to the wallet address of the artist.

For example, in a case where the transfer expense is 100 virtual currencies, 5 virtual currencies that are 5% of the transfer expense are given to the artist, on the basis of the contract contents. Note that the virtual currency of the possessor B in the smart contract may be deposited in advance. In this case, the corresponding amount of virtual currencies is given from the deposited virtual currency to the wallet address of the artist.

Note that in this embodiment, an example has been described in which the amount of virtual currencies given to the artist is calculated on the basis of the transfer expense, but the present invention is not limited thereto. For example, the fixed amount of virtual currencies (for example, 10 virtual currencies) may be given to the artist. Note that the operator or the like of the system may give the virtual currency to the artist.

Note that in FIG. 20, an example of the single authorized person has been described, but the present invention is not limited thereto. In the case of a plurality of authorized persons, it is possible to give an incentive to each of the authorized persons. Specifically, the server 1 acquires the authorized person ID and the wallet address of the authorized person of the analog record corresponding to the certificate in the certificate NFT from the authorized person DB 178, on the basis of the certificate ID and the management number of the analog record.

The server 1 generates the code of the smart contract for performing processing of giving an incentive to each of the authorized persons. The server 1 records in advance a transaction including the generated code of the smart contract in the blockchain 3. In the code of the smart contract, the execution condition which are necessary, the contract contents, the wallet address of each of the authorized persons, and the like, are described. In the contract contents, the distribution route (the distribution rule) of the incentive to each of the authorized persons is included.

The transaction includes the code of the smart contract, the token ID of the certificate NFT, the transfer expense, the transfer destination, and the electronic signature of each of the authorized persons. In a case where the transaction is coincident with the execution condition relevant to the transfer of the certificate NFT, the blockchain 3 gives the amount of virtual currencies determined on the contract contents from the wallet address of the transfer destination (the possessor B) to the wallet address of each of the authorized persons.

Specifically, the blockchain 3 calculates the incentive to each of the authorized persons through the smart contract, on the basis of the distribution route of the incentive. In the distribution route of the incentive, for example, the distribution ratio of the incentive to each of the authorized persons may be described. For example, the authorized person of the analog record includes an artist, a player, and an art director. The distribution ratio to the artist is 40%, the distribution ratio to the player is 30%, and the distribution ratio to the art director is 30%.

As described above, in a case where the incentive calculated by a predetermined ratio (for example, 5%) of the transfer expense is given to each of the authorized persons, on the basis of the contract contents, the incentive can be given to each of the authorized persons, on the basis of the distribution ratio to each of the authorized persons described above.

For example, in a case where the transfer expense is 100 virtual currencies, the blockchain 3 calculates 5 virtual currencies that are 5% of the transfer expense through the smart contract, on the basis of the contract contents. The blockchain 3 calculates the amount of virtual currencies to each of the authorized persons through the smart contract, on the basis of the distribution ratio described above.

For example, the amount of virtual currencies to the artist is 2 virtual currencies (5 virtual currencies×40%), the amount of virtual currencies to the player is 1.5 virtual currencies (5 virtual currencies×30%), and the amount of virtual currencies to the art director is 1.5 virtual currencies (5 virtual currencies×30%). The blockchain 3 gives the calculated amount of virtual currencies to the wallet address of each of the authorized persons through the smart contract.

Note that the distribution route of the incentive is not limited to the distribution ratio, for example, and may be the fixed amount of virtual currencies (for example, 2 virtual currencies).

FIG. 21 is a flowchart illustrating a processing procedure when giving an incentive by transferring the certificate NFT. Note that the same reference numerals will be applied to the contents overlapping with those in FIG. 19, and the description will be omitted. The control unit 311 of the node 31 of the blockchain 3 executes the processing of step S342, and then, executes the processing of giving an incentive (for example, a virtual currency) to the artist by the smart contract for giving an incentive, recorded in advance in the storage unit 312 (step S344). The control unit 311 of the node 31 executes the processing of step S343.

Note that for the analog record transferred a plurality of times, an incentive may be given to the first transfer source (a possessor) of the analog record. For example, in a case where the analog record or the certificate NFT corresponding to the certificate for the analog record is transferred, the server 1 may store the transfer information including the wallet address of the transfer source, and the like in the transfer DB 175. The server 1 acquires the wallet address of the first transfer source corresponding to the analog record from the transfer DB 175, and gives an incentive to the acquired wallet address.

Note that the processing of giving an incentive is not limited to the method of the wallet address, and for example, an account of a legal currency and the like may be used.

According to this embodiment, it is possible to transfer the certificate NFT from the first entity to the first user.

According to this embodiment, it is possible to transfer the certificate NFT from the first user to the second entity different from the first entity.

According to this embodiment, it is possible to give an incentive to the artist of the analog record corresponding to the certificate in the certificate NFT by transferring the certificate NFT.

### Embodiment 4

Embodiment 4 relates to a configuration in which an incentive is given to the authorized person of the sound source data of a sampling used for creating the sound source data of the analog record. Note that the description of the contents overlapping with those in Embodiments 1 to 3 will be omitted.

FIG. 22 is a block diagram illustrating a configuration example of the server 1 in Embodiment 4. Note that the same reference numerals will be applied to the contents overlapping with those in FIG. 16, and the description will be omitted. In the high-capacity storage unit 17, a sound source DB 176 is stored. In the sound source DB 176, the sound source data of a record, the sound source data of the sampling, and the like are stored.

FIG. 23 is an explanatory diagram illustrating an example of the record layout of the certificate DB 172 and the sound source DB 176 in Embodiment 4. Note that the same reference numerals will be applied to the contents overlapping with those in FIG. 11, and the description will be omitted.

The certificate DB 172 includes a record sound source ID column, a sampling sound source ID column, a sampling sound source NFT column, and a second user ID column. In the record sound source ID column, a record sound source ID for specifying the sound source data of the analog record is stored. In the sampling sound source ID column, a sampling sound source ID for specifying the sound source data of the sampling used for creating the sound source data of the analog record is stored.

In the sampling sound source NFT column, a sampling sound source NFT issued on the blockchain 3 is stored. In the second user ID column, the user ID of a second user who possesses the sound source data of the sampling is stored.

The sound source DB 176 includes a sound source ID column, a type column, a sound source data column, and a possessor ID column. In the sound source ID column, the ID of the sound source data that is uniquely specified is stored in order to identify each piece of sound source data. In the type column, the type of sound source data is stored. The type of sound source data includes the sound source data of the analog record, the sound source data of the sampling, and the like.

In the sound source data column, the sound source data of the analog record or the sound source data of the sampling is stored. In the possessor ID column, the user ID of the user who possesses the sound source data of the analog record, or the second user ID of the second user who possesses the sound source data of the sampling is stored.

It is possible to use the sound source data of a plurality of samplings when creating the sound source data of the analog record. The sampling is a music production method or an expression technique for producing a new piece of music by quoting and reconstructing the past music or a part of a sound source in the music. By incorporating the sound source data of the plurality of samplings into the sound source data of the analog record to be a creation target, it is possible to create the sound source data of the analog record.

Then, by transacting (transferring or the like) the certificate NFT corresponding to the analog record, or using the sound source data of the analog record, it is possible to not only give an incentive (for example, a virtual currency) to the authorized person of the analog record, but also give an incentive to the authorized person of the sound source data of the sampling used for creating the sound source data of the analog record.

FIG. 24 is an explanatory diagram illustrating an example of the record layout of the authorized person DB 178 in Embodiment 4. Note that the same reference numerals will be applied to the contents overlapping with those in FIG. 17, and the description will be omitted. The authorized person DB 178 includes a sound source type column and a sound source ID column. In the sound source type column, the type of sound source data (the sound source data of the analog record, the sound source data of the sampling, and the like) is stored. In the sound source ID column, a sound source ID for identifying the sound source data is stored.

FIG. 25 is an explanatory diagram illustrating the sampling sound source NFT corresponding to the sound source data of the sampling. The server 1 acquires the sound source data of the sampling used for creating sound source data 13a of the analog record. As illustrated, the sound source data of the sampling, for example, includes a sampling 13c and a sampling 13e. Note that in FIG. 25, an example of the sound source data of two samplings has been described, but the present invention is not limited thereto. The number of pieces of sound source data of the sampling used for creating the sound source data 13a of the analog record is not particularly limited.

The server 1, for the acquired sound source data of each of the samplings, generates the sampling sound source NFT corresponding to the sound source data of each of the samplings on the blockchain 3. Specifically, the server 1 generates a sampling sound source NFT 13d corresponding to the sampling 13c on the blockchain 3. The server 1 generates a sampling sound source NFT 13f corresponding to the sampling 13e on the blockchain 3.

The server 1 issues each of the generated sampling sound source NFTs to the second user who possesses the sound source data of the sampling corresponding to each of the sampling sound source NFTs through the blockchain 3. Specifically, the server 1 issues the generated sampling sound source NFT 13d to the second user who possesses the sampling 13c. The server 1 issues the generated sampling sound source NFT 13f to the second user who possesses the sampling 13e.

The server 1 associates the issued sampling sound source NFT 13d and sampling sound source NFT 13f with a certificate NFT 13b corresponding to the sound source data 13a of the analog record. The server 1 acquires the sampling sound source NFT 13d and the sampling sound source NFT 13f associated with the certificate NFT 13b by transacting the certificate NFT 13b or using the sound source data 13a of the analog record.

The server 1 gives an incentive to the authorized person of the sampling 13c corresponding to the acquired sampling sound source NFT 13d. The server 1 gives an incentive to the authorized person of the sampling 13e corresponding to the acquired sampling sound source NFT 13f. The type of authorized person of the sound source data of the sampling includes the copyright holder of the sound source data of the sampling, the possessor (the second user) of the sound source data of the sampling, or an artist, a player, a business, a label specialized for an analog record, an art director, or a photographer relevant to the sound source data of the sampling, and the like.

The incentive is information relevant to a value for which a legal currency, a virtual currency (crypto-asset), electronic money, a coupon, a point, or the like can be used. The incentive to each of the authorized persons, for example, may be calculated by a predetermined ratio (for example, 5%) of the transaction (transfer or the like) expense, or may be a fixed amount (for example, 10 virtual currencies).

The server 1 acquires the authorized person ID and the wallet address of a single or plurality of authorized persons corresponding to the sound source data of each of the samplings from the authorized person DB 178, on the basis of the certificate ID, the management number of the analog record, and the sound source ID of each of the samplings (the sampling 13c and the sampling 13e). The server 1 calculates the incentive to each of the authorized persons, on the basis of a predetermined distribution route of the incentive to each of the authorized persons.

In the distribution route of the incentive, for example, the distribution ratio of the incentive to each of the authorized persons may be described. Note that the distribution route of the incentive is not limited to the distribution ratio, and for example, may be the fixed amount of virtual currencies (for example, 2 virtual currencies). The server 1 gives the calculated incentive to the wallet address of each of the authorized persons of the sound source data of the sampling through the blockchain 3.

Hereinafter, an example of processing of giving an incentive to the authorized person of the sampling 13c will be described. For example, the authorized person of the sampling 13c includes an artist and a player. The distribution ratio to the artist is 60%, and the distribution ratio of the player is 40%. For example, in a case where the transfer expense is 100 virtual currencies, the server 1 calculates the incentive (5 virtual currencies) by a predetermined ratio (for example, 5%) of the transaction (transfer or the like) expense.

The server 1 calculates the amount of virtual currencies to each of the authorized persons of the sampling 13c, on the basis of the calculated incentive, and the distribution ratio described above. For example, the incentive to the artist is 3 virtual currencies (5 virtual currencies×60%), and the incentive to the player is 2 virtual currencies (5 virtual currencies×40%). The server 1 gives the calculated amount of virtual currencies to the wallet address of each of the authorized persons (the artists and the players) of the sampling 13c through the blockchain 3.

Note that an example has been described in which an incentive is given to the authorized person of the sound source data of the sampling by the processing described above, but the present invention is not limited thereto. It is possible to give an incentive to both of the authorized person of the analog record corresponding to the certificate in the certificate NFT and the authorized person of the sound source data of a single or plurality of samplings used for creating the sound source data of the analog record.

In this case, the server 1, for example, calculates an incentive to the authorized person of the analog record, and the authorized person of the sound source data of each of the samplings (for example, a sampling A and a sampling B) from the incentive calculated by a predetermined ratio (for example, 5%) of the transaction (transfer or the like) expense, on the basis of a predetermined distribution route.

Then, the server 1 gives an incentive to each of the authorized persons (the artists, the players, the labels, or the like) of the sound source data of the analog record from the calculated incentive to the authorized person of the analog record, on the basis of a predetermined distribution route of the incentive to each of the authorized persons. Note that the processing of giving an incentive to the authorized person of the analog record is the same as that in Embodiment 3, and thus, the description will be omitted.

The server 1, as with the processing described above, gives an incentive to each of the authorized persons (the artists, the photographers, the businesses, or the like) of the sound source data of each of the samplings (for example, the sampling A and the sampling B) from the calculated incentive to the authorized person of the sound source data of each of the samplings (for example, the sampling A and the sampling B), on the basis of the predetermined distribution route of the incentive to each of the authorized persons.

In addition, in a case where the sound source data of the analog record is provided in a subscription system, the incentive to the authorized person can be calculated on the basis of a usage situation such as the number of times of performing playback within a certain period of time. For example, it may be set such that the incentive to be obtained increases as the number of times of performing playback within a certain period of time increases. The subscription is a business model in which the purchase price of a product, the usage fee of a service, or the like is not charged each time, but a fee is charged for rights to be capable of using the product or the service for a certain period of time.

Note that the processing of giving an incentive to the authorized person may be performed by a smart contract, a transaction, a banking system, or the like.

FIG. 26 is a flowchart illustrating a processing procedure when issuing the sampling sound source NFT. The control unit 11 of the server 1 acquires the sound source data of the sampling used for creating the sound source data of the analog record through the communication unit 13 or the input unit 14 (step S151).

The control unit 11 stores the acquired sound source data of the sampling in the sound source DB 176 of the high-capacity storage unit 17 (step S152). Specifically, the control unit 11 allocates the sound source ID to the acquired sound source data of the sampling. The control unit 11 stores a type that is “sampling”, the sound source data of the sampling, and the second user ID of the second user who possesses the sound source data of the sampling in the sound source DB 176, as one record, in association with the allocated sound source ID. Note that in a case where the processing (steps S151 to S152) described above is executed once, the execution of the processing can be omitted from the next time.

The control unit 11 calculates the hash value of sampling information relevant to the sound source data of the sampling by using the cryptographic hash function (step S153). The sampling information includes the second user ID and the like. Note that in the sampling information, the name of the second user may be included instead of the second user ID. The control unit 11 transmits the sound source ID of the sampling and the hash value of the sampling information to any node 31 of the blockchain 3 through the communication unit 13 (step S154).

The control unit 311 of the node 31 of the blockchain 3 receives the sound source ID of the sampling and the hash value of the sampling information transmitted from the server 1 through the communication unit 313 (step S351). The control unit 311 of the node 31 records the hash value of the sampling information in the storage unit 312, in association with the received sound source ID of the sampling (step S352).

The control unit 311 of the node 31, for example, generates the sampling sound source NFT for the second user by using ERC721 (S353). The control unit 311 records the token ID, the possessor address (the owner ID) of the second user, and the token URI of the generated sampling sound source NFT in the storage unit 312 (step S354).

Note that in a case where the sampling sound source NFT is issued to an administrator, the administrator transfers the sampling sound source NFT that the administrator possesses to the second user. In this case, the control unit 311 of the node 31 takes over the token ID and the token URI (the location of the metadata) of the sampling sound source NFT. The control unit 311 of the node 31 changes the possessor address of the sampling sound source NFT from the possessor address of the administrator to the possessor address of the second user. The control unit 311 of the node 31 records the token ID (no change), the changed possessor address, the token URI (no change), and the like of the transferred sampling sound source NFT.

The control unit 311 transmits the generated sampling sound source NFT to the server 1 by the communication unit 313 (step S355). The control unit 11 of the server 1 receives the sampling sound source NFT transmitted from the node 31 of the blockchain 3 by the communication unit 13 (step S155).

The control unit 11 stores the received sampling sound source NFT in the certificate DB 172 of the high-capacity storage unit 17, in association with the certificate NFT (step S156). Specifically, the control unit 11 stores the sound source ID of the sampling, the sampling sound source NFT (the token ID, the possessor address, the token URI, and the like), and the user ID of the second user who possesses the sampling sound source NFT in the certificate DB 172, in association with the certificate NFT corresponding to the sound source data of the analog record.

The control unit 11 transmits the sampling sound source NFT issued on the blockchain 3 to the user terminal 2 of the second user who possesses the sound source data of the sampling through the communication unit 13 (step S157). The control unit 11 ends the processing.

FIG. 27 is a flowchart illustrating a processing procedure when giving an incentive to the authorized person of the sound source data of the sampling. The control unit 11 of the server 1 acquires a profit amount obtained by transacting (for example, transferring) the certificate NFT or using (for example, subscribing) the sound source data of the analog record, for example, from a profit management server or the like through the communication unit 13 (step S161).

The control unit 11 acquires the authorized person information (such as the authorized person ID and the wallet address) of a single or plurality of persons corresponding to the sound source data of each of the samplings from the authorized person DB 178 of the high-capacity storage unit 17, on the basis of the certificate ID, the management number of the analog record, and the sound source ID of each of the samplings (step S162).

The control unit 11 calculates an incentive (for example, a virtual currency) to each of the authorized persons of the sound source data of each of the samplings from the acquired profit amount, on the basis of a predetermined distribution route of the incentive (step S163). Note that the distribution route of the incentive may be stored in advance in the storage unit 12 or the high-capacity storage unit 17. The control unit 11 creates a transaction for giving an incentive to each of the authorized persons of the sound source data of each of the samplings (step S164). In the sound source data of each of the samplings, the transaction includes the incentive to each of the authorized persons of the sound source data of each of the samplings, the wallet address of each of the authorized persons, the transaction date and time, and the like.

The control unit 11 transmits the created transaction to any node 31 of the blockchain 3 through the communication unit 13 (step S165). The control unit 311 of the node 31 of the blockchain 3 receives the transaction transmitted from the server 1 by the communication unit 313 (step S361). The control unit 311 of the node 31 executes processing of giving an incentive to the wallet address of each of the authorized persons, in accordance with the received transaction (step S362).

Note that the processing of giving an incentive is not limited to the method of the wallet address, and for example, an account of a legal currency and the like may be used.

According to this embodiment, it is possible to generate sampling sound source NFT corresponding to the sound source data of the sampling used for creating the sound source data of the analog record on the blockchain 3.

According to this embodiment, it is possible to give an incentive to the authorized person of the sound source data of the sampling used for creating the sound source data of the analog record by transacting the certificate NFT, or using the sound source data of the analog record corresponding to the certificate NFT.

### Embodiment 5

Embodiment 5 relates to a configuration in which the sound source data is output when a playback request for the sound source data of the analog record is accepted. Note that the description of the contents overlapping with those in Embodiments 1 to 4 will be omitted. The sound source data of the analog record is the metadata of the certificate NFT, and the sound source data is stored in the sound source DB 176.

FIG. 28 is a flowchart illustrating a processing procedure when outputting the sound source data in accordance with the playback request for the sound source data. The control unit 21 of the user terminal 2 accepts the playback request for the sound source data corresponding to the certificate NFT from the user who possesses the certificate NFT by the input unit 24 (step S271). The control unit 21 transmits the certificate ID of the certificate corresponding to the certificate NFT, and the accepted playback request for the sound source data to the server 1 by the communication unit 23 (step S272).

The control unit 11 of the server 1 receives the certificate ID and the playback request for the sound source data transmitted from the user terminal 2 by the communication unit 13 (step S171). The control unit 11 acquires the certificate NFT from the certificate DB 172 of the high-capacity storage unit 17, on the basis of the received certificate ID (step S172).

The control unit 11 acquires the token URI of the certificate NFT (that is attribute indicating the location of the metadata with respect to the certificate NFT) from any node 31 of the blockchain 3 by the communication unit 13, in accordance with the received playback request for the sound source data, on the basis of the token ID of the acquired certificate NFT (step S173). Note that the control unit 11 may acquire the token URI of the certificate NFT from the certificate DB 172 of the high-capacity storage unit 17, on the basis of the certificate ID.

The location of the metadata indicated in the token URI, for example, is the URL of the sound source data of the analog record. The control unit 11 acquires the sound source data of the analog record posted on a site designated by the URL of the sound source data of the analog record through the communication unit 13 (step S174).

Note that the present invention is not limited to the processing of acquiring the sound source data of the analog record described above. For example, the control unit 11 acquires the record sound source ID corresponding to the certificate NFT from the certificate DB 172 of the high-capacity storage unit 17, on the basis of the certificate ID. The control unit 11 may acquire the sound source data of the analog record corresponding to the certificate NFT from the sound source DB 176 of the high-capacity storage unit 17, on the basis of the acquired record sound source ID.

The control unit 11 transmits the acquired sound source data of the analog record to the user terminal 2 by the communication unit 13 (step S175).

The control unit 21 of the user terminal 2 receives the sound source data of the analog record transmitted from the server 1 by the communication unit 23 (step S273). The control unit 21 plays back the received sound source data of the analog record (step S274). The control unit 21 ends the processing.

According to this embodiment, in a case where the playback request for the sound source data of the analog record is accepted, the sound source data can be output.

### Embodiment 6

Embodiment 6 relates to a configuration in which a service charge involved in the transfer or the exchange of the certificate NFT and the analog record corresponding to the certificate NFT is determined. Note that the description of the contents overlapping with those in Embodiments 1 to 5 will be omitted.

FIG. 29 is a block diagram illustrating a configuration example of the server 1 in Embodiment 6. Note that the same reference numerals will be applied to the contents overlapping with those in FIG. 22, and the description will be omitted. In the high-capacity storage unit 17, an exchange DB 177 is stored. In the exchange DB 177, information relevant to the exchange of the certificate NFT and the analog record corresponding to the certificate NFT is stored.

FIG. 30 is an explanatory diagram illustrating an example of the record layout of the transfer DB 175 and the exchange DB 177 in Embodiment 6. Note that the description of the contents overlapping with those in FIG. 17 will be omitted.

The transfer DB 175 includes a transfer expense column and a service charge column. In the transfer expense column, an expense involved in the transfer of the certificate NFT and the analog record corresponding to the certificate NFT is stored. In the service charge column, a service charge involved in the transfer is stored.

The exchange DB 177 includes an exchange ID column, an exchange source column, an exchange destination column, an exchange date and time column, and a service charge column. In the exchange ID column, the ID of exchange data that is uniquely specified is stored in order to identify the exchange data of the certificate NFT and the analog record corresponding to the certificate NFT.

The exchange source column includes a certificate ID column, a management number column, a user ID column, and a possessor address column. In the certificate ID column, the certificate ID for specifying the certificate (a first certificate) for the analog record to be an exchange source is stored. In the management number column, the management number of the analog record to be the exchange source is stored. In the user ID column, the user ID of the user (the first user) who possesses the certificate NFT (a first certificate NFT) to be the exchange source is stored. In the possessor address column, the possessor address of the first user is stored.

The exchange destination column includes a certificate ID column, a management number column, a user ID column, and a possessor address column. In the certificate ID column, the certificate ID for specifying the certificate (a second certificate) for the analog record to be an exchange destination is stored. In the management number column, the management number of the analog record to be the exchange destination is stored. In the user ID column, the user ID of the user (the second user) who possesses the certificate NFT (a second certificate NFT) to be the exchange destination is stored. In the possessor address column, the possessor address of the second user is stored.

In the exchange date and time column, the information of the date and time when the certificate NFT and the analog record corresponding to the certificate NFT are exchanged is stored. In the service charge column, a service charge involved in the exchange is stored.

First, processing of determining the service charge involved in the transfer of the certificate NFT and the analog record corresponding to the certificate NFT will be described. When transferring the certificate NFT and the analog record corresponding to the certificate NFT from the first user (the transfer source) to the second user (the transfer destination), the entity receives the analog record from the first user, and delivers the analog record to the second user.

Note that the transfer processing is the same as the transfer processing described in Embodiment 3, and thus, the description will be omitted.

In a case where the entity receives the analog record from the first user, and delivers the analog record to the second user when transferring the certificate NFT and the analog record corresponding to the certificate NFT from the first user to the second user, the server 1 accepts a transfer completion notification from the entity. The server 1 determines a part of the expense involved in the transfer for the entity as the service charge, in accordance with the accepted transfer completion notification.

Specifically, the server 1 calculates the service charge, in accordance with the expense involved in the transfer. For example, in a case where the transfer expense is 100 virtual currencies, 5 virtual currencies that are 5% of the transfer expense may be determined as the service charge. Note that the service charge may be a fixed price (for example, 3 virtual currencies). Note that the virtual currency of the first user (the transfer source) may be deposited in advance on the blockchain 3. In this case, the corresponding amount of virtual currencies is given from the deposited virtual currency to the wallet address of the entity.

The server 1 stores the transfer information in the transfer DB 175, in association with the certificate ID. The server 1 transmits the determined service charge to an entity terminal 4 (not illustrated) of the entity through the blockchain 3, a banking system, or the like. The entity terminal 4 is a terminal device performing the acceptance and the transmission of the transfer completion notification, the reception and the display of the service charge, and the like. The entity terminal 4, for example, is an information processing device such as a smart phone, a mobile phone, a wearable device such as Apple Watch, a tablet, or a personal computer terminal.

FIG. 31 is a flowchart illustrating a processing procedure when determining the service charge involved in the transfer. Note that the same reference numerals will be applied to the contents overlapping with those in FIG. 19, and the description will be omitted. The control unit 11 of the server 1 executes the processing of step S144, and then, receives the transfer completion notification of the analog record transmitted from the entity terminal 4 by the communication unit 13 (step S176). The control unit 11 executes the processing of step S145.

The control unit 11 determines a part of the expense involved in the transfer as the service charge (step S177). For example, in a case where the expense involved in the transfer is 100 virtual currencies, 5 virtual currencies that are 5% of the transfer expense are determined as the service charge.

The control unit 11 stores the transfer information in the transfer DB 175 of the high-capacity storage unit 17, in association with the certificate ID and the management number of the analog record (step S178). Specifically, the control unit 11 stores the transfer date and time, the user information (the user ID and the possessor address) of the first user (the transfer source), the user information (the user ID and the possessor address) of the second user (the transfer destination), the expense involved in the transfer, and the determined service charge in the transfer DB 175, as one record, in association with the certificate ID and the management number of the analog record.

The control unit 11 gives the determined service charge from the wallet address of the first user to the wallet address of the entity through the blockchain 3 (step S179). Note that the processing of giving the service charge may be executed by a smart contract. Note that the processing of giving the service charge is not limited to the method of the wallet address, and for example, an account of a legal currency by a banking system, and the like may be used.

Next, processing of determining the service charge involved in the exchange of the certificate NFT and the analog record corresponding to the certificate NFT will be described. It is possible to exchange the first certificate NFT of the first user and the first analog record corresponding to the first certificate NFT, the second certificate NFT of the second user and the second analog record corresponding to the second certificate NFT between the first user and the second user.

When exchanging the certificate NFT and the analog record corresponding to the certificate NFT between the first user and the second user, the entity receives the first analog record and the second analog record, and delivers the second analog record to the first user, and in a case where the first analog record is delivered to the second user, the server 1 accepts an exchange completion notification from the entity. The server 1 determines the service charge involved in the exchange for the entity, in accordance with the accepted exchange completion notification.

The processing of exchanging the certificate NFT between the first user and the second user is performed on the blockchain 3. Specifically, in a case where an exchange instruction of the certificate NFT between the first user and the second user is accepted, the server 1 creates an exchange transaction of the certificate NFT between the first user and the second user.

The created transaction includes the token ID of the first certificate NFT, the token ID of the second certificate NFT, the possessor address of the first user (hereinafter, will be referred to as the first user address), the possessor address of the second user (hereinafter, will be referred to as a second user address), an exchange date and time, and the like.

The server 1 transmits the created transaction to any node 31 of the blockchain 3. The node 31 of the blockchain 3 receives the transaction transmitted from the server 1. The node 31 executes the processing of exchanging the first certificate NFT and the second certificate NFT, in accordance with the received transaction.

Specifically, the node 31 takes over the token ID and the token URI (the location of the metadata) of the first certificate NFT and the second certificate NFT. The node 31 changes the possessor address of the first certificate NFT from the first user address to the second user address. The node 31 changes the possessor address of the second certificate NFT from the second user address to the first user address.

The node 31 records the token ID (no change), the changed possessor address (the second user address), the token URI (no change), and the like of the exchanged first certificate NFT. The node 31 records the token ID (no change), the changed possessor address (the first user address), the token URI (no change), and the like of the exchanged second certificate NFT.

The node 31 of the blockchain 3 transmits the exchanged first certificate NFT and second certificate NFT to the server 1. The server 1 receives the exchanged first certificate NFT and second certificate NFT transmitted from the node 31 of the blockchain 3.

The server 1 determines the service charge involved in the exchange for the exchanged first certificate NFT and second certificate NFT. The service charge, for example, may be a fixed price (for example, 10 virtual currencies). Alternatively, the service charge may be calculated by a predetermined ratio (for example, 5%), on the basis of the purchase price of the analog record corresponding to the first certificate NFT or the second certificate NFT. Note that the service charge may be charged to both of the first user to be the exchange source and the second user to be the exchange destination.

Note that the virtual currency of the first user and the second user may be deposited in advance on the blockchain 3. In this case, the corresponding amount of virtual currencies is given from the deposited virtual currency to the wallet address of the entity.

The server 1 allocates the exchange ID to the exchanged first certificate NFT and second certificate NFT. The server 1 stores information relevant to the first certificate NFT (the exchange source), information relevant to the second certificate NFT (the exchange destination), the exchange date and time, and the service charge in the exchange DB 177, in association with the allocated exchange ID.

The server 1 transmits the determined service charge to the entity terminal 4 of the entity through the blockchain 3, a banking system, or the like.

FIG. 32 is a flowchart illustrating a processing procedure when determining the service charge involved in the exchange. The control unit 11 of the server 1 acquires the exchange instruction of the first certificate NFT and the second certificate NFT from the user terminal 2 of the first user or the second user through the communication unit 13 (step S181). The control unit 11 creates a transaction for exchanging the first certificate NFT and the second certificate NFT, in accordance with the acquired exchange instruction (step S182).

The transaction includes the token ID of the first certificate NFT, the token ID of the second certificate NFT, the possessor address of the first user, the possessor address of the second user, the transaction date and time, and the like. The control unit 11 transmits the created transaction to any node 31 of the blockchain 3 through the communication unit 13 (step S183). The control unit 311 of the node 31 of the blockchain 3 receives the transaction transmitted from the server 1 by the communication unit 313 (step S381).

The control unit 311 of the node 31 executes the processing of exchanging the first certificate NFT and the second certificate NFT, in accordance with the received transaction (step S382). Specifically, the control unit 311 takes over the token ID and the token URI of the first certificate NFT and the second certificate NFT. The control unit 311 changes the possessor address of the first certificate NFT from the first user address to the second user address. The control unit 311 changes the possessor address of the second certificate NFT from the second user address to the first user address. The control unit 311 records the token ID, the possessor address, the token URI, and the like for the exchanged first certificate NFT and second certificate NFT.

The control unit 311 of the node 31 transmits the exchanged certificate NFT to the server 1 by the communication unit 313 (step S383). The control unit 11 of the server 1 receives the exchanged certificate NFT transmitted from the node 31 by the communication unit 13 (step S184). The control unit 11 receives the exchange completion notification of the analog record transmitted from the entity terminal 4 by the communication unit 13 (step S185).

The control unit 11 updates the exchanged first certificate NFT and second certificate NFT in the certificate DB 172 of the high-capacity storage unit 17 (step S186). Specifically, the control unit 11 updates the exchanged first certificate NFT and the user ID of the second user in the certificate DB 172, on the basis of the certificate ID of the exchanged first certificate NFT. The control unit 11 updates the exchanged second certificate NFT and the user ID of the first user in the certificate DB 172, on the basis of the certificate ID of the exchanged second certificate NFT.

The control unit 11 determines a part of the expense involved in the exchange as the service charge (step S187). For example, the service charge is a fixed price (for example, 10 virtual currencies). The control unit 11 stores exchange information in the exchange DB 177 of the high-capacity storage unit 17 (step S188). Specifically, the control unit 11 allocates the exchange ID to the exchanged first certificate NFT and second certificate NFT. The control unit 11 stores the information relevant to the first certificate NFT, the information relevant to the second certificate NFT, the exchange date and time, and the service charge in the exchange DB 177, in association with the allocated exchange ID.

The information relevant to the first certificate NFT includes the certificate ID of the certificate corresponding to the first certificate NFT, the management number of the analog record corresponding to the certificate, the user ID of the user (the second user) who possesses the first certificate NFT, the possessor address, and the like. The information relevant to the second certificate NFT includes the certificate ID of the certificate corresponding to the second certificate NFT, the management number of the analog record corresponding to the certificate, the user ID of the user (the first user) who possesses the second certificate NFT, the possessor address, and the like.

The control unit 11 gives the determined service charge to the wallet address of the entity through the blockchain 3 (step S189). Specifically, the control unit 11 gives the determined service charge from the wallet address of the first user to the wallet address of the entity through the blockchain 3. In addition, the control unit 11 gives the determined service charge from the wallet address of the second user to the wallet address of the entity.

Note that the processing of giving the service charge may be executed by a smart contract. Note that the processing of giving the service charge is not limited to the method of the wallet address, and for example, an account of a legal currency by a banking system, and the like may be used.

According to this embodiment, it is possible to determine the service charge involved in the transfer or the exchange of the certificate NFT and the analog record corresponding to the certificate NFT.

According to this embodiment, it is possible to give the determined service charge to the entity to which the analog record is delivered when transferring or exchanging the certificate NFT and the analog record corresponding to the certificate NFT.

### Embodiment 7

Embodiment 7 relates to a configuration in which an avatar image corresponding to the user and the jacket image of the analog record corresponding to the certificate NFT are displayed in a metaverse space. Note that the description of the contents overlapping with those in Embodiments 1 to 6 will be omitted. The metaverse space is a three-dimensional virtual space that is constructed on a game, an application, the internet, or the like.

In a case where the user possesses the certificate NFT, the avatar image corresponding to the user and the jacket image of the analog record corresponding to the certificate NFT can be simultaneously displayed in the metaverse space. The avatar image is the image of an entity or character to be the alter ego of the user who appears on the metaverse space of the game, the application, the internet, or the like.

FIG. 33 is an explanatory diagram illustrating an example of a display screen of the metaverse space. The screen is a display screen of a metaverse space 20. In the metaverse space 20, a certificate NFT issuing authority 14a, an avatar image 14b1, an avatar image 14b2, an avatar image 14b3, a jacket image 14c1, a jacket image 14c2, a certificate NFT 14d1, and a certificate NFT 14d2.

The certificate NFT issuing authority 14a is an issuing authority accepting an issuance request for the certificate NFT on the metaverse space. The avatar image 14b1 is an avatar image corresponding to the first user on the metaverse space 20. The avatar image 14b2 is an avatar image corresponding to the second user on the metaverse space 20. The avatar image 14b3 is an avatar image corresponding to a third user on the metaverse space 20.

The jacket image 14c1 is the jacket image of the analog record that the first user possesses. The jacket image 14c2 is the jacket image of the analog record that the second user possesses. The certificate NFT 14d1 is the image of the certificate NFT that the first user possesses. The certificate NFT 14d2 is the image of the certificate NFT that the second user possesses.

The server 1 generates the display screen of the metaverse space 20. Specifically, the server 1 executes a program, a platform, or the like for generating the metaverse space 20 to generate the metaverse space 20. The server 1 performs rendering on the avatar image, the jacket image of the analog record, the image of the certificate NFT, or the like on the generated metaverse space 20.

The server 1 transmits the display screen of the metaverse space 20 including each of the images subjected to the rendering to the user terminal 2. The user terminal 2 receives and displays the display screen of the metaverse space 20 transmitted from the server 1.

In a case where the issuance request for the certificate NFT is accepted by the certificate NFT issuing authority 14a, the user terminal 2 transmits the accepted issuance request to the server 1. The server 1 issues the certificate NFT corresponding to the certificate for the analog record that the user possesses on the blockchain 3, in accordance with the issuance request for the certificate NFT transmitted from the user terminal 2. Note that the processing of issuing the certificate NFT is the same as that in Embodiment 2, and thus, the description will be omitted.

The server 1 determines whether each of the first user, the second user, and the third user possesses the certificate NFT. For example, the server 1 determines that the first user and the second user possess the certificate NFT, and the third user does not possess the certificate NFT.

The server 1 acquires the jacket image of the analog record corresponding to the certificate NFT from the appraisal information DB 171, on the basis of the certificate ID corresponding to the certificate NFT that the first user possesses. In order to simultaneously display the avatar image 14b1 corresponding to the first user, and the jacket image 14c1 of the analog record corresponding to the certificate NFT that the first user possesses in the metaverse space 20, the server 1 transmits (outputs) the avatar image 14b1 corresponding to the first user, the jacket image 14c1 of the analog record, and the certificate NFT 14d1 to the user terminal 2.

The server 1 acquires the jacket image of the analog record corresponding to the certificate NFT from the appraisal information DB 171, on the basis of the certificate ID corresponding to the certificate NFT that the second user possesses. In order to simultaneously display the avatar image 14b2 corresponding to the second user, and the jacket image 14c2 of the analog record corresponding to the certificate NFT that the second user possesses in the metaverse space 20, the server 1 transmits the avatar image 14b2 corresponding to the second user, the jacket image 14c2 of the analog record, and the certificate NFT 14d2 to the user terminal 2.

As illustrated, the user terminal 2 simultaneously displays the avatar image 14b1 corresponding to the first user, the jacket image 14c1 of the analog record, and the certificate NFT 14d1, transmitted from the server 1, in the metaverse space 20. The user terminal 2 simultaneously displays the avatar image 14b2 corresponding to the second user, the jacket image 14c2 of the analog record, and the certificate NFT 14d2, transmitted from the server 1, in the metaverse space 20.

In addition, for the third user who does not possess the certificate NFT, the server 1 transmits only the avatar image 14b3 corresponding to the third user to the user terminal 2. The user terminal 2 displays the avatar image 14b3 corresponding to the third user transmitted from the server 1 in the metaverse space 20.

Note that in this embodiment, an example has been described in which the metaverse space 20 is generated (constructed) on the server 1, but the present invention is not limited thereto. For example, the metaverse space 20 generated on an external information processing device (for example, a metaverse server) can be used. In this case, the server 1 transmits the image of the certificate NFT issued on the blockchain 3, and the jacket image of the analog record corresponding to the certificate NFT to the metaverse server, in association with the user ID of the target user registered (logged) in the metaverse space 20.

The metaverse server receives the user ID, the image of the certificate NFT, and the jacket image of the analog record, transmitted from the server 1. The metaverse server transmits the display screen of the metaverse space 20 including the image of the certificate NFT, the jacket image, and an avatar image corresponding to each of the target users to the user terminal 2, on the basis of the user ID of each of the target users.

FIG. 34 is a flowchart illustrating a processing procedure when displaying the avatar image and the jacket image in the metaverse space. The control unit 11 of the server 1 generates the metaverse space to be a target (step S191). Specifically, the control unit 11 executes a program, a platform, or the like for generating the metaverse space to generate the metaverse space. The control unit 11 performs rendering on the avatar image, the jacket image of the analog record, the image of the certificate NFT, or the like on the generated metaverse space. The control unit 11 acquires a plurality of target users registered in the metaverse space (step S192).

The control unit 11 acquires the user ID of one user among the acquired target users (step S193). The control unit 11 acquires an avatar image corresponding to the user on the metaverse space, on the basis of the acquired user ID (step S194). The control unit 11 determines whether the user possesses the certificate NFT, on the basis of the acquired user ID (step S195).

Specifically, the control unit 11 collates whether the user purchases the certificate, on the basis of the user ID in the purchase DB 174 of the high-capacity storage unit 17. In a case where the user purchases the certificate, the control unit 11 collates whether the certificate NFT is issued for the certificate in the certificate DB 172 of the high-capacity storage unit 17, on the basis of the certificate ID of the purchased certificate. In a case where the certificate NFT is issued for the certificate, the control unit 11 determines that the user possesses the certificate NFT.

In a case where the user does not possess the certificate NFT (NO in step S195), the control unit 11 transitions to the processing of step S197 described below. In a case where the user possesses the certificate NFT (YES in step S195), control unit 11 acquires the jacket image of the analog record corresponding to the certificate NFT from the appraisal information DB 171 of the high-capacity storage unit 17, on the basis of the certificate ID corresponding to the certificate NFT (step S196).

The control unit 11 determines whether the user is the last user among the plurality of target users (step S197). In a case where the user is not the last user (NO in step S197), the control unit 11 returns to the processing of step S193. In a case where the user is the last user (YES in step S197), the control unit 11 transmits the acquired metaverse space, the avatar image corresponding to each of the users, and the jacket image of the analog record corresponding to the certificate NFT to the user terminal 2 by the communication unit 13 (step S198).

The control unit 21 of the user terminal 2 receives the metaverse space, the avatar image, and the jacket image of the analog record, transmitted from the server 1, by the communication unit 23 (step S291). The control unit 21 displays the received avatar image and jacket image of the analog record in the metaverse space through the display unit 25 (step S292).

Specifically, for the user who possesses the certificate NFT, the control unit 21 simultaneously displays the avatar image corresponding to the user and the jacket image of the analog record corresponding to the certificate NFT in the metaverse space through the display unit 25. For the user who does not possess the certificate NFT, the control unit 21 displays only the avatar image corresponding to the user in the metaverse space through the display unit 25.

According to this embodiment, it is possible to display the jacket image of the analog record corresponding to the certificate NFT that the user possesses in the metaverse space, in association with the avatar image corresponding to the user.

The embodiments disclosed herein should be considered as illustrative in all respects and not restrictive. The scope of the present invention is indicated by the claims, but not the meaning described above, and is intended to include the meaning equivalent to the claims and all modifications within the scope.

The respects described in each embodiment can be combined with each other. In addition, the independent and dependent claims set forth in the claims can be combined with each other in any and all combinations, regardless of the format of reference. Further, the claims are in a format in which a claim refers to two or more other claims (the format of a multiple dependent claim), but the present invention is not limited thereto.

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

1-21. (canceled)

22. An information processing method, comprising:
storing appraisal information including an artist name and a title of an analog record in a storage unit, and
outputting a certificate including the artist name and the title of the analog record on the basis of the appraisal information stored in the storage unit.

23. The information processing method according to claim 22,
wherein at least one of a catalog number, a label name, a label image, a jacket image, a matrix number, a weight, and a production year of the analog record is further stored in the storage unit, and
the certificate including at least one of the artist name, the title, the catalog number, the label name, the label image, the jacket image, the matrix number, the weight, and the production year of the analog record is output.

24. The information processing method according to claim 22,
wherein a matrix number and information indicating an initial matrix number of the analog record are further stored in the storage unit, and
the certificate including the artist name, the title, the matrix number, and the information indicating the initial matrix number of the analog record is output.

25. The information processing method according to claim 22,
wherein in association with a matrix number of the analog record, image data of the matrix number is further stored in the storage unit, and
the certificate including the artist name, the title, the matrix number, and the image data of the matrix number of the analog record is output.

26. The information processing method according to claim 22,
wherein a code in which a certificate ID for identifying the certificate is described is read by a user terminal to acquire the certificate ID,
the certificate is acquired on the basis of the acquired certificate ID, and
the acquired certificate is output to the user terminal.

27. The information processing method according to claim 22,
wherein, in a case where a user purchases the analog record, information relevant to the user is stored in the storage unit.

28. The information processing method according to claim 22,
wherein the certificate for the analog record is stored in association with a certificate ID,
a certificate NFT corresponding to the stored certificate is generated on a blockchain system, and
the generated certificate NFT is issued to a user who purchases the analog record.

29. The information processing method according to claim 28,
wherein a hash value of the appraisal information of the analog record is output to the blockchain system in association with the certificate ID.

30. The information processing method according to claim 28,
wherein the certificate is created for each analog record, and
the certificate ID and identification information for identifying a user who possesses the certificate NFT are stored in association with the certificate NFT corresponding to the certificate.

31. The information processing method according to claim 28,
wherein a smart contract for giving an incentive to an authorized person of the analog record corresponding to the certificate in the certificate NFT by transferring the certificate NFT is stored on the blockchain system.

32. The information processing method according to claim 28,
wherein transfer information indicating that the analog record, the certificate for the analog record, and the certificate NFT corresponding to the certificate are transferred from a first entity to a first user is stored.

33. The information processing method according to claim 32,
wherein the transfer information indicating that the analog record, the certificate for the analog record, and the certificate NFT corresponding to the certificate are transferred from the first user to a second entity different from the first entity is stored.

34. The information processing method according to claim 28,
wherein the certificate in the certificate NFT is output to a user terminal of a user who possesses the certificate NFT.

35. The information processing method according to claim 28,
wherein at least one of information relevant to an artist of the analog record corresponding to the certificate in the certificate NFT, and a content relevant to music included in the analog record is output to a user terminal of a user who possesses the certificate NFT.

36. The information processing method according to claim 28,
wherein a sampling sound source NFT corresponding to sound source data of sampling used for creating sound source data of the analog record is generated on the blockchain system,
the generated sampling sound source NFT is issued to a second user who possesses the sound source data of the sampling,
the issued sampling sound source NFT is associated with the certificate NFT corresponding to the certificate for the analog record, and
an incentive is given to an authorized person of the sound source data of the sampling corresponding to the sampling sound source NFT by transacting the certificate NFT or using the sound source data of the analog record.

37. The information processing method according to claim 28,
wherein, in a case where the user possesses the certificate NFT, in order to simultaneously display an avatar image corresponding to the user and a jacket image of an analog record corresponding to the certificate NFT in a metaverse space, the avatar image and the jacket image are output.

38. The information processing method according to claim 28,
wherein, upon transfer of the certificate NFT and the analog record corresponding to the certificate NFT to a second user, a part of an expense involved in the transfer for an entity receiving the analog record from the user and delivering the analog record to the second user is determined as a service charge.

39. The information processing method according to claim 28,
wherein, upon exchange of a first certificate NFT of a first user as well as a first analog record corresponding to the first certificate NFT and a second certificate NFT of a second user as well as a second analog record corresponding to the second certificate NFT between the first user and the second user, a service charge involved in the exchange for an entity receiving the first analog record and the second analog record, delivering the second analog record to the first user and delivering the first analog record to the second user is determined.

40. The information processing method according to claim 28,
wherein sound source data of the analog record is metadata of the certificate NFT, and
in a case where a playback request for the sound source data is accepted from the user who possesses the certificate NFT, the sound source data is output.

41. An information processing device, comprising:
one or more processing devices; and
one or more storage devices storing instructions for causing the one or more processing devices to execute the following processing of:
storing appraisal information including an artist name and a title of an analog record; and
outputting a certificate including the artist name and the title of the analog record, on the basis of the appraisal information stored in the storage unit.

42. A non-transitory computer-readable recording medium with a program recorded causing a computer to execute processing of:
storing appraisal information including an artist name and a title of an analog record in a storage unit; and
outputting a certificate including the artist name and the title of the analog record, on the basis of the appraisal information stored in the storage unit.
